(19) United States
(12) Patent Application Publication
(10) Pub. No.: US 2014/0330464 A1
(43) Pub. Date: Nov. 6, 2014

(54) METHOD AND SYSTEM FOR CONTROL OF APPARATUS

(71) Applicant: John Lautzenhiser, Hamilton, IN (US)

(72) Inventor: John Lautzenhiser, Hamilton, IN (US)

(21) Appl. No.: 14/194,184

(22) Filed: Feb. 28, 2014

Related U.S. Application Data
(60) Provisional application No. 61/770,904, filed on Feb. 28, 2013.

(51) Int. Cl. A61G 5/04; A61G 5/10; B60L 15/10

(52) U.S. Cl. CPC A61G 5/04; B60L 15/10; A61G 5/10; B60L 2200/34; B60L 2260/26
USPC 701/22; 307/140

(57) ABSTRACT

The present invention relates generally to manually controlling an apparatus and/or a multiplexer. More particularly, the present invention relates to controlling an apparatus and/or a multiplexer by signals that preferably include both proportional-output signals and rate-of-change signals. The signals may be generated by either tilt transducers or switches capable of producing an “on” and “off” signal. The signals may be used to control a primary apparatus connected to a control means and may alternatively be used to control a secondary apparatus connected to the same control means.

### CROSS-REFERENCE TO RELATED APPLICATION

The present application claims benefit of priority to and is a continuation of U.S. Provisional Pat. Application Ser. No. 61/770,904, filed Feb. 28, 2013, and entitled METHOD AND SYSTEM FOR CONTROL OF APPARATUS (Lautzenhiser), which is hereby incorporated by reference herein in its entirety.

### BACKGROUND OF THE INVENTION

1. Field of the Invention

The present invention relates generally to manually controlling an apparatus and/or a multiplexer. More particularly, the present invention relates to controlling an apparatus and/or a multiplexer by signals that preferably include proportional-output signals, rate-of-change signals, and open/closed output signals.

2. Description of the Related Art

In recent years there has been an increasing awareness of the importance, not only providing for the needs of handicapped persons, but also of utilizing them as productive members of society, rather than keeping them partially or wholly dependent upon others.

Fortunately, this enlightened view has coincided with giant strides in technology, particularly electronics and computer-based technology, and this increase in technology has been reflected by giant strides in electrically-propelled wheelchairs.

The prior art includes electrically-propelled wheelchairs in which control of start, stop, and steering has been achieved by manually-actuated X-Y transducers, commonly called “joysticks.”

Lautzenhiser et al., in U.S. Pat. No. 4,906,906, issued 6 Mar. 1990, and in U.S. Pat. No. 4,978,899, issued 18 Dec. 1990, teach wheelchairs that are propelled by pulse-width-modulated voltages, that are dynamically braked by shorting the motors, that are made freewheeling without the expense and complexity of a clutch, and in which tremor control is provided, so that those who have hand tremors can easily and accurately control power wheelchairs.

The prior art includes attempts to control wheelchairs by sipping or puffing on a tube. However, controllability of sip-and-puff units has been marginal, especially for those who depend upon a respirator or ventilator for breathing, since they can puff into a tube only while exhaling, and sipping is even more difficult.

In U.S. Pat. No. 5,635,807, which issued on 3 Jun. 1997, Lautzenhiser teaches electric control systems that provide nonlinear relationships between X-Y mechanical inputs and resultant differential speeds of two propulsion motors. These nonlinear relationships between X-Y mechanical inputs and electrical outputs allow many handicapped persons, who otherwise would be limited to sip-and-puff systems, to control a wheelchair by joystick movement.

Perhaps even more significantly, when a joystick is replaced with two tiny transducers or input devices that are mounted to a person's head, or to an other body member, these nonlinear relationships allow easy and accurate control of both speed and steering of power wheelchairs by means of body-component movements. For instance, a person who is paralyzed from the neck down can perform all control functions of an electrically propelled wheelchair except for connecting and disconnecting power to the system.

In U.S. Pat. No. 5,635,807, Lautzenhiser also provides adjustable transducer sensitivity, steering sensitivity control that is adjustable, selectively-adjustable signal limiting so that maximum speeds can be selectively adjusted, and overrange shutdown.

In U.S. patent application Ser. No. 09/652,395, filed 31 Aug. 2000, Lautzenhiser et al. teach a tilt-axis X-Y input device that may be mounted to a body component, such as the head or a hand of a user, null compensators that automatically compensate for errors in attaching the X-Y input device to a head or other body component, a null-width generator that adjustably provides a neutral zone to help an operator find and hold a neutral position, a turn-signal conditioner that provides easier control of turns including elimination of “fishtailing,” tremor control for those with body tremors, adjustable tilt-axis sensitivity to selectively match the motor skills of the user, and overrange shutdown as a safety feature.

In the same patent, Lautzenhiser et al. teach control of a second device, such as a computer and its cursor, both of which may utilize voice-recognition technology to provide the required switching functions.

Even with the great strides that have been provided by head and other body-component control of both speed and turns of power wheelchairs, much still needs to be accomplished. Many still are unable to control their own safety except by the use of a call button. Many are unable to control their own comfort and productivity needs, such as adjusting leg supports, head supports, backrests, heating, cooling, and lighting. And many are unable to control productivity devices, such as computers, and entertainment devices, such as radio or television.

In the industry, apparatus for controlling safety, productivity, comfort, and entertainment devices have been called “Environmental Control Units” (ECU). Therefore, this terminology is used extensively in the detailed description.

Furthermore, there are many individuals whose condition has left them unable to operate a power wheelchair using normal control methods. These individuals may have very limited control over their head and other body-member. For these individuals, using their head or single body-member to control both X and Y movement may be difficult or impossible. What is needed is a control method to enable individuals with extremely limited physical ability to control a power wheelchair or ECU using only a single range of motion in their head or other body-member.

### BRIEF SUMMARY OF THE INVENTION

The present invention includes rate-of-change control devices, timed-opportunity switches, and multiplexers.

More particularly, the present invention provides rate-of-change control devices that actuate in response to adjustable rate-of-change thresholds, timed-opportunity switches that can be actuated by one or more appropriately-timed inputs, and multiplexers, that can be used by physically-handicapped persons to control such things as wheelchair and hospital bed positioning actuators, lighting, entertainment, communication, computer and productivity devices.

The timed-opportunity switches and the multiplexers can be actuated by any type of momentary-contact switch. However, preferably, the rate-of-change control devices of the present invention are used in combination with mechanical-to-electrical transducers.

With regard to the rate-of-change control devices, repeated ones of output signals, from transducers such as X-Y tilt sensors, are differentiated with respect to time, and then discriminated to provide rate-of-change switching functions that can be used to control start-up (power on) of power wheelchairs, to control additional external devices, and/or to provide a safety shutdown for power wheelchairs. Additionally, the rate-of-change control devices may be used to control wheelchair and hospital bed positioning actuators, lighting, entertainment, communication, computer and productivity devices

If an input position of a mechanical-to-electrical transducer is “y,” then the output is equal to f(y). Thus, it is equally accurate to speak of differentiating the input or the output, although from a practical standpoint, the electrical output is differentiated.

While highly successful results have been achieved by differentiating only once, thereby producing values that are a function of the velocity of the input “y,” alternately, the electrical outputs are differentiated twice, thereby providing values that are a function of the acceleration of the input “y.”

The rate-of-change control devices have two basic advantages. One is that they can use the output of transducers, such as head-attached X-Y tilt sensors that are used to control speed and steering of wheelchairs, to provide switching functions. An other advantage is that the rate-of-change control devices are self-centering, or self-nulling. That is, they function by differentiating an output, and the differential of a constant is zero. Therefore, when an output of a transducer is constant, the rate-of-change control device does not produce an output.

By differentiating signals generated by a two-axis transducer, such as an X-Y tilt sensor, two rate-of-change signals are produced for each axis, one for an increase in the output signal, and one for a decrease in the output signal.

Preferably, the rate-of-change control device that is used with the timed-opportunity switch and the signal conditioner that is shown herein, produces a single switching output from the four rate-of-change signals.

That is, switching occurs when any one of four rates-of-change is beyond a preselected threshold. For instance, when used with a head-attached X-Y input device, a nod of the head can be used to produce a logic “1” output, and returning the head to a level position can be used to produce a second logic “1” output.

In a simplified embodiment of the rate-of-change control devices that are included herein, two rate-of-change switching outputs are produced in response to outputs from a single-axis transducer. One rate-of-change output is produced whenever the rate-of-change of an increasing output exceeds a predetermined magnitude. And, the other rate-of-change output is provided whenever the rate-of-change of a decreasing output exceeds a predetermined magnitude. However, this embodiment can be simplified further by eliminating one comparator. Then, only one output will be produced.

In a slightly more complex embodiment of the rate-of-change control devices, two rate-of-change switching outputs are produced from a single-axis transducer, the two rate-of-change outputs are combined to produce a single switching output, and the single switching output is used to control a relay.

In other embodiments of the rate-of-change control devices, switching outputs are produced that are combinations of one or more sequential rate-of-change signals. For instance, an “1” output can be made to equal A AND B, by holding A until B occurs, or visa versa.

Or a logic “1” can be made to equal “A AND A,” where “A AND A” refers to two “A” signals that are sequential, and the first “A” signal is held until the second “A” signal occurs.

Therefore, although only four logic “1” signals are available from a two-axis transducer, by using digital logic, a large number of logic outputs can be produced.

One of the rate-of-change control devices, or any momentary-contact switch, may be used to initiate the timed-opportunity switch. If a switched signal is provided within a first window-of-opportunity, power is supplied to a first apparatus, such as an electrically-propelled wheelchair. Or, if a switched signal is provided within a second window-of-opportunity, the environmental control unit becomes controllable by the rate-of-change control device, or any momentary-contact switch.

In an other application of the rate-of-change control devices, a rate-of-change signal exceeding a preset threshold will shut down the electrically-propelled wheelchair. This signal will occur in such instances as an X-Y transducer being knocked off of the head of a user, if some force jars the head of the user, and even if the cord from the X-Y transducer is given a sudden jerk.

It is important to remember that a constant value, differentiated as a function of time, is zero. Therefore, no matter what constant output a transducer may produce when it is at null, or is not being actuated, dy/dt is zero.

Therefore, while rate-of-change control devices have been shown and described in conjunction with proportional-output transducers that are used to control apparatus, such as a power wheelchair, the rate-of-change control devices of the present invention may be used with any transducer that will produce a change in output in response to an input.

Further, since the neutral position of a transducer, that is used with the rate-of-change control device, is whatever input position the transducer has immediately preceding a rate-of-change that is of sufficient magnitude to cause switching, there is no requirement that the transducer have a neutral position, that its output be even relatively repeatable, that its output be even relatively free of drift, or that it be even relatively free of hysteresis.

In another embodiment of the invention, motion control is provided through one or more switches. The switches can be any combination of switches including infrared, magnetic, mechanical, optical, proximity, ultrasonic or any type of switches capable of providing an open/closed output. A device, such as a powered wheelchair, may be operated optimally by 4 switches configured to provide motion control or alternatively by 3, 2 or 1 switch(es) similarly configured. Full control using fewer than four switches is enabled through the use of a set of one or more flip-flop circuits that allow the input from one or more of the switches to step through a series of control means.

As defined herein, a rate-of-change control device includes a differentiator and whatever additional components may be required to perform the desired switching functions in response to an input received from a transducer. When a transducer is included with the rate-of-change control device, the combination is a rate-of-change switch.

In a first embodiment, the invention provides a method which comprises: actuating a switch; disabling control of a device in response to the actuation of the switch; selectively actuating a transducer; generating a control signal in response to the actuation of the transducer; storing a voltage offset proportional to the control signal generated by the actuation of the transducer; enabling control of the device; selectively increasing or decreasing the voltage of the control signal; and operating the device using the control signal from the transducer wherein the signal is modified by the voltage offset.

In a second embodiment, the invention provides an apparatus comprising: means, comprising first and second transducers that are connected to a powered wheelchair, for moving said powered wheelchair in X and Y direction in response to body member actuating said transducers; means for conditioning a control signal generated by the selective actuating of said transducers; means for storing and applying a voltage offset to the control signal; means for selecting control of either an external device or the powered wheelchair; and means for selectively increasing or decreasing the voltage of the control signal to enable operation one of a set of unique powered wheelchairs.

In a third embodiment, the invention provides a method which comprises: actuating a switch; powering on a device in response to said actuation; if a specified number of input switches are connected to the device, operating the device in a first mode of operation by selectively operating at least one control switch connected to the device wherein the operation of the at least one control switch generates a control signal; if fewer than the specified number of input switches are connected to the device, selecting a second mode of operation in response to a unique operation of the at least one control switch connected to the device; selectively increasing or decreasing the voltage of the control signal; and operating the device in the second mode of operation by selectively operating the at least one control switch connected to the device. The switch used in this method may be either an active or a passive switch.

In a fourth embodiment, the invention provides an apparatus comprising: means, comprising at least one active or passive switch that are connected to a powered wheelchair, for moving said powered wheelchair in X and Y direction in response to body member actuating said at least one active or passive switch; means, comprising at least one active or passive switch, for alternating control of the powered wheelchair between positive X, negative X, positive Y, and negative Y directions in response to body member actuating said at least one active or passive switch; means for conditioning a control signal generated by the selective actuating of said at least one active or passive switch; means for selecting control of either an external device or the powered wheelchair; and means for selectively increasing or decreasing the voltage of the control signal to enable operation one of a set of unique powered wheelchairs.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a block diagram of control circuitry that may be either analog or digital.

FIG. 1A is a block diagram of control circuitry operated by tilt transducers for control of a powered wheelchair or USP device;

FIG. 2 is a block diagram of an alternate embodiment of control circuitry operated by one or more switches for control of a powered wheelchair or external device;

FIG. 3 is a schematic drawing of input, orientation and inverting circuitry that are part of the control system in FIG. 1;

FIG. 4 is a schematic drawing of buffer and signal limiting circuitry that are part of the control system in FIG. 1;

FIG. 5 is a schematic drawing of over-range limiting circuitry that is part of the control system in FIG. 1;

FIG. 6 is a schematic drawing of over-rate limiting circuitry that is part of the control system in FIG. 1;

FIG. 7 is a schematic drawing of activation and delay circuitry that are part of the control system in FIG. 1;

FIG. 8 is a schematic drawing of a null width generator and signal conditioner that are part of the control system in FIG. 1;

FIG. 9 is a schematic drawing of a lockout circuit that is part of the control system in FIG. 1;

FIG. 10 is a schematic drawing of an X-Y input proportioning circuit that is part of the control system in FIG. 1;

FIG. 11 is a schematic drawing of a voltage offset and Z-axis circuit that is part of the control system in FIG. 1;

FIG. 12 is a schematic drawing of a system monitoring circuit that is part of the control system in FIG. 1;

FIG. 13 is a schematic drawing of an emergency stop circuit that is part of the control system in FIG. 1;

FIG. 14 is a schematic drawing of switch connection circuit that is part of the control system in FIG. 2;

FIG. 15 is a schematic drawing of a Y-axis conditioning circuit that is part of the control system in FIG. 2;

FIG. 16 is a schematic drawing of an X-axis conditioning circuit that is part of the control system in FIG. 2;

FIG. 17 is a schematic drawing of a flip-flop control circuit for selecting from forward, reverse, left and right control that is part of the control system in FIG. 2;

FIG. 18 is a schematic drawing of a flip-flop circuit for selecting from forward and reverse control that is part of the control system in FIG. 2;

FIG. 19 is a schematic drawing of a flip-flop circuit for selecting from left and right control that is part of the control system in FIG. 2;

FIG. 20 is a schematic drawing of a flip-flop circuit for selecting from Y-axis low and high speed control that is part of the control system in FIG. 2;

FIG. 21 is a schematic drawing of USP control circuitry comprising a universal signal port that is part of the control system in FIG. 2;

FIG. 22 is a schematic drawing of an active/standby circuit and a flip-flop reset circuit that are part of the control system in FIG. 2;

FIG. 23 is a schematic drawing of a rapid deceleration inhibitor that is part of the control system in FIG. 2;

FIG. 24 is a schematic drawing of a lock-out circuit that is part of the control system in FIG. 2;

FIG. 25 is a schematic drawing of a voltage offset and Z-axis circuit that is part of the control system in FIG. 2.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

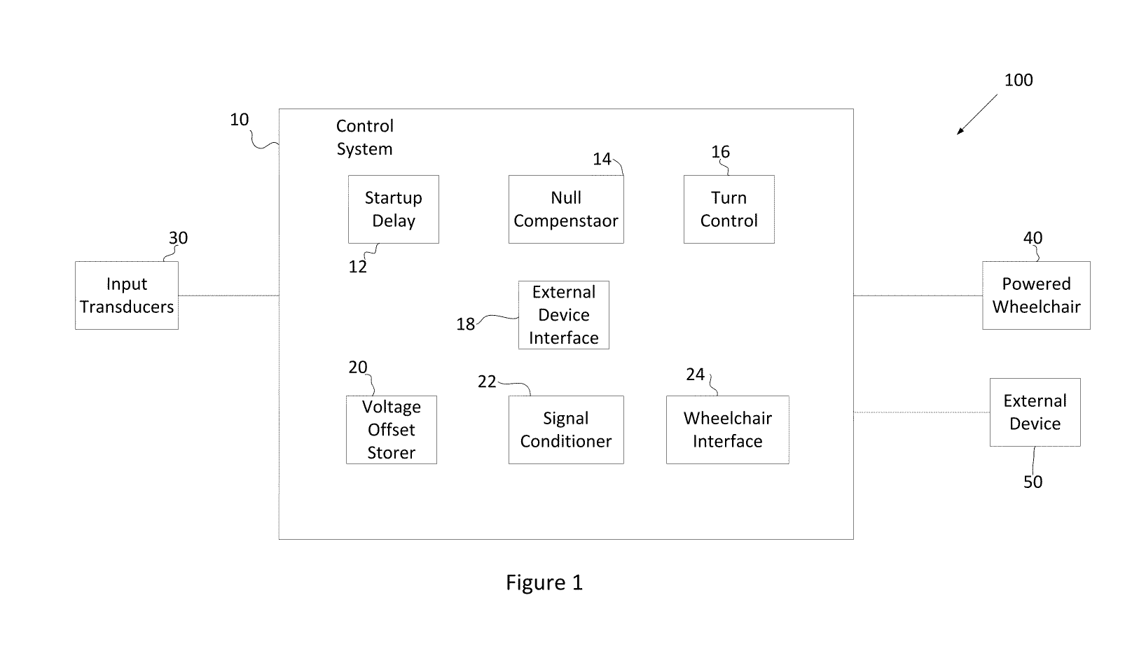

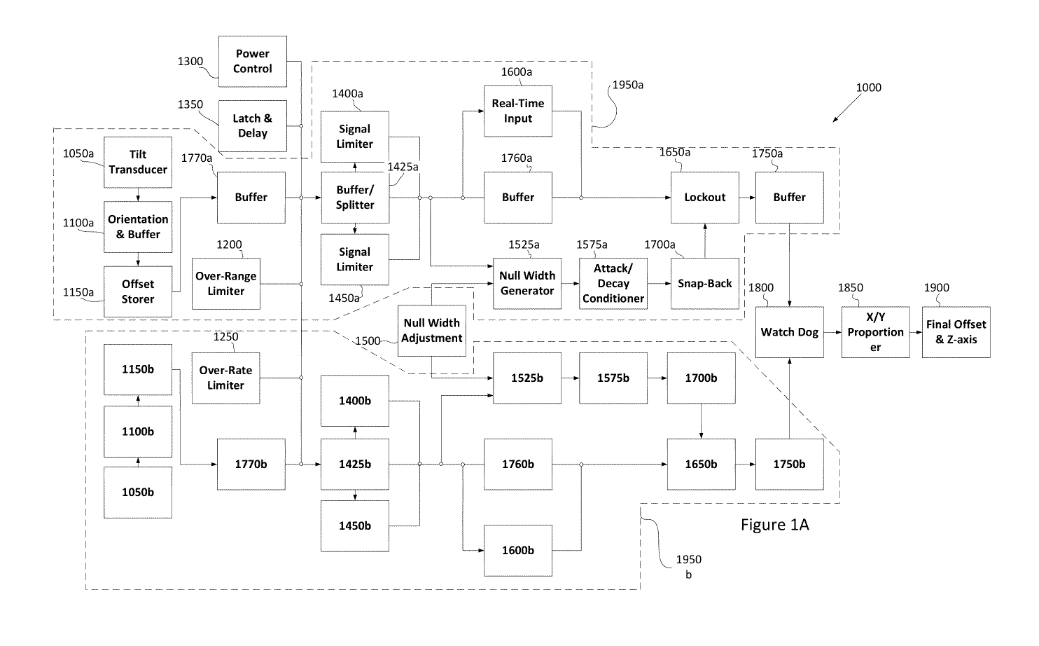

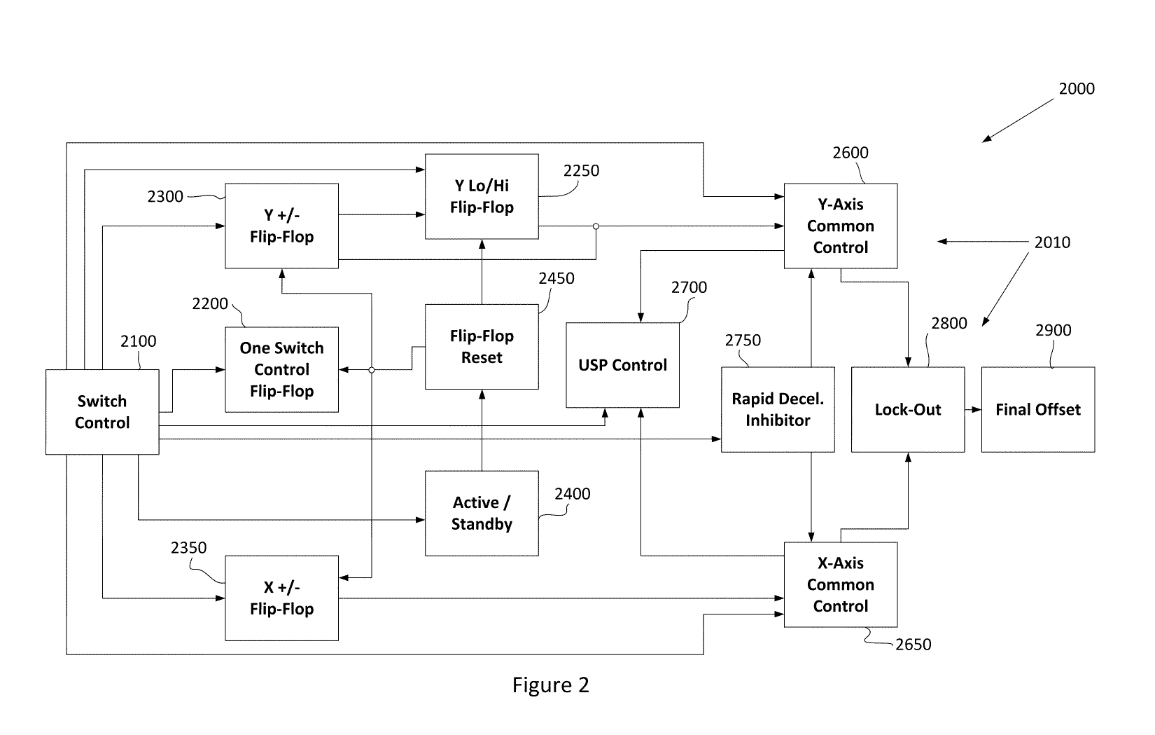

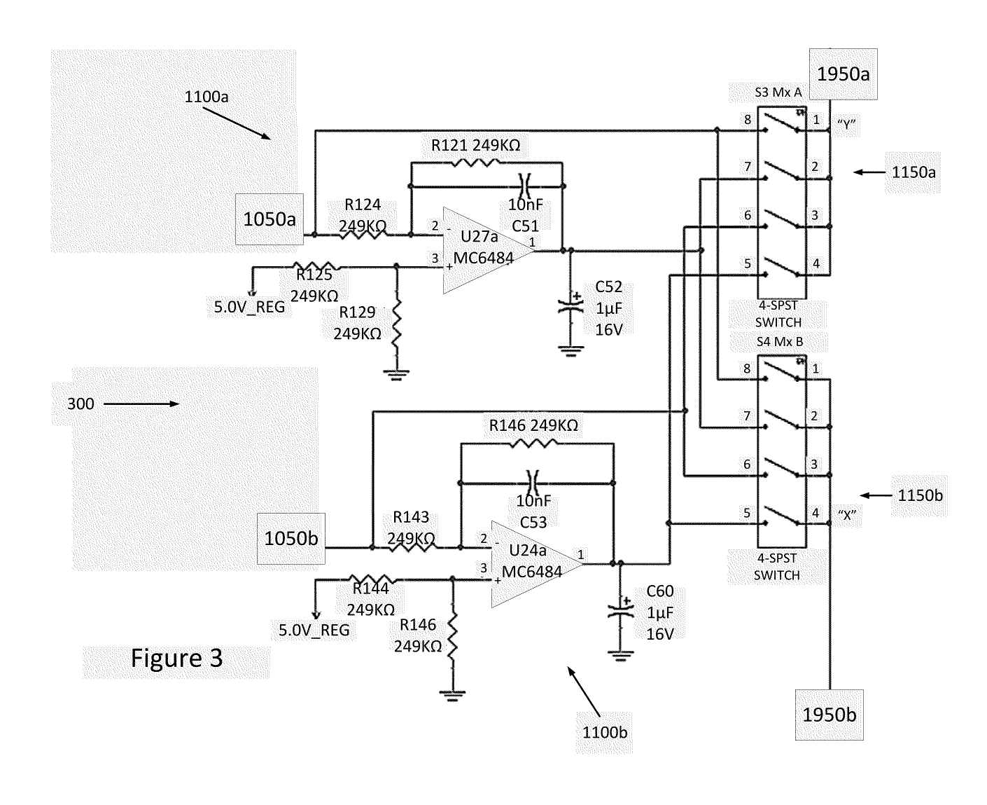

In each of FIGS. 1, 1A and 2, the present invention is illustrated by a block diagram that generally capsulizes the previously discussed functions and intercomponent relationships of a preferred embodiment of the present invention, illustrating by functional blocks, how the present invention can be practiced using analog components, digital components, or a combination of analog and digital components. Then, FIGS. 3 to 25 provide a detailed description of the present invention in embodiments constructed with analog and digital components.

With reference now to FIG. 1, a first embodiment of the invention is depicted. The control device 100 comprises the control system 10, the input transducers 30, the powered wheelchair 40, and may also optionally comprise an external device 50. The control system 10 comprises a startup and delay controller 12, a null compensator 14, a turn control module 16, an external device interface 18, a voltage offset storer 20, a signal conditioner module 22, and a wheelchair interface module 24. The control system 10 and its modules may comprise either analog or digital components. For example, the control system 10 may be either a microprocessor-based system or may be comprised of analog components such as op-amps, capacitors, resistors, and diodes for example. In a microprocessor configuration, the control system 10 will also comprise a memory to store information needed for the operation of its constituent modules. In an analog configuration, the control system 10 would comprise a set of circuits and discrete components configured to condition an input signal from input transducers 30 to provide for control of powered wheelchair 40 and/or external device 50.

With reference now to FIG. 1A, an embodiment of the invention as shown in FIG. 1, control system 1000, is depicted. The control system 1000 is comprised of separate X and Y signal input and conditioning channels. Y input comes from tilt transducer 1050a while X input comes from tilt transducer 1050b. Signal input from transducers 1050a and 1050b goes through orientation buffer 1100a and 1100b respectively. Input for the X and Y axis control can be inverted using signal orientation selectors 1150a and 1150b.

Continuing to refer to FIG. 1A, only one of the signal conditioners, 1950a, will be described, since the signal conditioners 1950a and 1950b are identical. The signal conditioning performed by signal conditioners 1950a and 1950b may include tremor control, maximum speed limiting, soft starts, soft stops, signal proportioning, turn-signal conditioning, and/or null width adjustment which are taught herein by Lautzenhiser in U.S. Pat. No. 5,635,807 and/or by Lautzenhiser et al. in U.S. patent application Ser. No. 10/352,345, both of which are incorporated herein by reference.

The system 1000 is powered on using power control 1300. When the system 1000 is powered on using power control 1300, the latch and delay controller 1350 is also activated. When the latch and delay controller 1350 is activated, the input voltage into the system 1000 is held at a neutral voltage until the input from the transducer 1050a is determined to be centered or within a determined null width. More specifically, a resistor biases the circuit high and switches between buffer 1770a and buffer/splitter 1425a is closed. The voltage downstream from the switch is held at a neutral signal voltage of 5 volts. Upstream from the switch a capacitor, in this embodiment a 6.8 μF 100 volt ceramic capacitor, stores an offset voltage from the tilt transducer 1050a's input signal voltage. When the delay in the latch and delay controller 1350 times out it pulls the voltage on the circuit low, opening the switch between buffer 1770a and buffer/splitter 1425a, and buffer/splitter 1425a begins to receive the voltage signals from the transducer 1050a that are offset by the voltage offset stored in the capacitor. Alternatively, an activator/detector module may be attached to a BNC connection port between buffer 1770a and buffer/splitter 1425a. The activator/detector module detects any reclining or tilting of the seat of a powered wheelchair device. If the seat is reclined or tilted by the user, a switch is closed causing a neutral voltage of 5 volts to be sent downstream, halting user control. A new voltage offset is stored in a capacitor, and when the switch is opened the new voltage offset is applied to the input signal voltage from tilt transducer 1050a.

Before being routed by buffer/splitter 1425a the signal is processed by both the over-range limiter 1200 and over-rate limiter 1250. The function of the over-range limiter 1200 is to halt signal input if the input signal is over a predetermined limit. The over-range limiter 1200 will send a signal to the lockout circuit 1650 if the input signal from either of the tilt transducers 1050a or 1050b is over an acceptable input range. The signal from the over-range limiter 1200 to the lockout circuit 1650 will be sent until the signal from the tilt transducers is back within the acceptable input range. The function of the over-rate limiter 1250 is to filter out unwanted or unsafe acceleration signals from either the X or Y input. The over-rate limiter 1250 will send a signal to the lockout circuit 1650 if rate of change in the input signal from the tilt transducers 1050a or 1050b is over an acceptable limit.

The voltage signal from the buffer/splitter 1425a is limited by the signal limiter 1400a and 1450a. If an external device is connected to the system 1000, real time, unbuffered, input can be sent to the USP connected external device through real-time input circuit 1600a. The voltage signal is simultaneously processed by the buffer 1760a and null width generator 1525a.

The null width generator 1525a receives a null width voltage from null width adjustment circuit 1500. The null width voltage is used to specify a null width or “dead zone” wherein any voltage signal from the tilt transducer 1050a will be interpreted as “null” or neutral. The null width adjustment circuit 1500 can be used to adjust the upper and lower limits of the null width voltage to be used in comparisons by the null width generator 1525a. The null width generator 1525a compares the signals from the buffer/splitter 1425a, which has been limited by signal limiters 1400a and 1450a, to the null voltage provided by the null width adjustment circuit 1500. If the voltage signal is within the null voltage range, the null voltage generator 1525a will supply a null or neutral voltage signal, effectively ignoring the original voltage signal. If the voltage signal exceeds the limits of the null voltage the voltage signal will be further conditioned by the signal conditioner 1950a. The null width generator 1525a may also be adapted to send a signal to a display device to provide a visual indication that the tilt transducer 1050a is in a centered or neutral position.

The attack/decay conditioner 1575a provides for a rapid decay and return to neutral of the signal voltage when the tilt transducer 1050a begins to return to a centered position. This feature prevents over-steering and provides for rapid braking or deceleration.

Still with reference to FIG. 1A, the lockout circuit 1650a is represented as being connected to buffer 1760a. However, in alternative embodiments, lockout circuit 1650a may also be directly connected to over-range limiter 1200, over-rate limiter 1250, watch dog circuit 1800, and may also comprise an emergency stop circuit 1675. When activated, the lockout circuit 1650a sends out a neutral voltage signal to return the output to a neutral state, bypassing any inputs from tilt transducer 1050a.

The voltage signal is then further buffered by buffer 1750a before being checked by watch dog circuit 1800. The watch dog circuit 1800 functions as a system safeguard. If any circuits or modules upstream of the watch dog circuit 1800 malfunction, the watch dog circuit 1800 will determine that the voltage signal at the watch dog circuit is in an error state. If the voltage signal is in an error state, the watch dog circuit 1800 will send a signal to the emergency stop circuit 1675, which will then activate the lockout circuit 1650a. If the emergency stop circuit 1675 is activated by the watch dog circuit 1800 or through any other means, the entire system 1000 must be powered off and on to reset the emergency stop circuit 1675.

If the lockout circuit 1650a has not been activated and the voltage signal is not in an error state as determined by the watch dog circuit 1800, the voltage signal is further conditioned by the X/Y proportioner 1850. The X/Y proportioner 1850 compares the voltage signals from the transducers 1050a and 1050b representing control of the Y and X axes respectively. The purpose of the X/Y proportioner is to keep the device controlled by the system 1000 from performing undesirable turning or acceleration maneuvers. For example, if the signal voltage for control of the Y axis is in a high positive state for a high rate of forward motion, the X/Y proportioner 1850 will condition the signals for the Y signal voltage to prevent the signal voltage for the Y axis from also being in a high positive state. The Y input signal is conditioned non-linearly as a function of the X input signal, and the X input signal is not changed or reduced. This proportional conditioning prevents a device controlled by the system 1000 from “fishtailing” or performing other undesirable or unsafe actions.

A final voltage offset is applied to the signal voltage by the final offset and Z-axis circuit 1900. The offset to be applied is selectable by the user. The voltage offset allows the control system 1000 to be used with a variety of different devices to enable compatibility with a variety of different devices. The voltage offset and Z-axis circuit 1900 can also be used to supply a reference voltage signal for a “Z-axis” to be used with certain devices.

With reference now to FIG. 2, a second embodiment of the invention, control system 2000, is depicted. Control system 2000 is a power wheelchair drive control device with multiple input ports. The control system may utilize 4, 3, 2, or 1 switch(es) to provide user control of a powered wheelchair or other device. The control system 2000 comprises a set of one or more proximity switches, or any other switch that provides open/closed output for motion control, connected to one switch control 2100 which provide signal voltages which are used to operate one or more devices connected to control system 2000. Through the use of one or more switches connected to switch control 2100, a user may control a device connected to the system 2000 using only one axis, a single directional input on one axis, or any combination of a single directional input on one axis and both directional inputs on another axis. For example, a user may operate forward, reverse, left, and right control of a device connected to the control system 2000 using only a single switch connected to the switch control 2100 and may step through the control outputs until the desired control output is selected. A user may also operate left and right control using two switches, and use an other switch to operate forward and reverse control.

Operation of the control system 2000 is enabled when the user operates a switch connected to the active/standby port on switch control 2100. When this switch is operated, a signal is sent to the active/standby circuit 2400. When the signal is received at the active/standby circuit 2400, flip-flop circuits 2200, 2250, 2300, and 2350 are reset to their starting state, and user control of the control system 2000 is enabled. However, no reset is performed if the flip flop circuits are in their default state.

The user may connect one or more switches to switch control 2100 to enable control of a device connected to the control system 2000. For motion control, a maximum of four (4) switches can be used. This can be any combination of switches including mechanical, proximity, ultrasonic, infrared, or any type of switches capable of providing an open/closed output. By selecting multiple switch ports, the control system 2000 can be operated with 3, 2, or 1 switch(es) for motion or device control in the event of a progressive illness such as ALS. The switch connectors, switch jacks and/or switch ports will accommodate and interface with both passive switches such as an Able Net Jelly Bean Twist 10033400, and active switches such as an Omron capacitive proximity sensor requiring a source of power such as E2K-F10MC1. If three or fewer switches are used, one or more of the input switches used for motion control are used to control motion in more than one direction. For example, a flip-flop circuit may be used to allow a single switch to step through the control outputs, and the resulting movement of the power wheelchair would step through forward and reverse and/or left and right motion control. Any combination of input switches may be used and the input switches may be placed anywhere on the user's body or wheelchair where the user has adequate body or body member control to operate the switches.

In a two switch configuration for the Y axis, a first switch allows the user to control the +Y axis, and a second switch allows the user to control the −Y axis. If the first switch is operated by the user, a signal is sent from the switch control 2100 to Y-axis common control circuit 2600 for +Y axis control. In this state, input from the switch will be conditioned to provide +Y axis control. If the second switch is operated by the user, a signal is sent from the switch control 2100 to Y-axis common control circuit 2600 for −Y axis control. In this state, input from the second switch conditioned to provide only −Y axis control.

In a single switch configuration for the Y axis, a switch allows the user to control either the + or −Y axis control by stepping through both control methods. In the default, or starting state, Y+/− flip-flop circuit 2300 provides for user control of the +Y axis. If the user operates the switch, a signal is sent from switch control 2100 to the Y+/− flip-flop circuit 2300 which switches to enable user control of the −Y axis. The next operation of the switch will return the Y+/− flip-flop circuit 2300 to the default state, providing user control of the +Y axis.

User selection of X axis control is performed in a similar manner to Y axis control. The user may connect one or two switches to provide the user with + and −X axis control. In a two switch configuration for the X axis, a first switch allows the user to operate +X axis control, and a second switch allows the user to operate −X axis control. If the first switch is operated by the user, a signal is sent from the switch control 2100 to X-axis common control circuit 2650 for +X axis control. In this state, input from the first switch will be conditioned to provide +X axis control. If the second switch is operated by the user, a signal is sent from the switch control 2100 to X-axis common control circuit 2650 for −X axis control. In this state, input from the second switch conditioned to provide −X axis control.

In a single switch configuration for the X axis, a switch allows the user to operate either + or −X axis control by stepping through both control methods. In the default, or starting state, X+/− flip-flop circuit 2350 provides for user control of the +X axis. If the user operates the switch, a signal is sent from switch control 2100 to the X+/− flip-flop circuit 2350 which switches to enable user control of the −X axis. The next operation of the switch will return the X+/− flip-flop circuit 2350 to the default state, providing user control of the +X axis.

Still referring to FIG. 2, the user may also connect a single switch to switch control 2100 to enable +/−X and Y axis control through the use of a single switch. In this configuration, each operation of the switch steps through the control methods of +Y, +X, −Y, −X. The selection of the control method is performed by one switch control flip-flop circuit 2200. In the default state, user control will be of the +Y axis through the default state of the Y+/− flip-flop circuit 2300. Each operation of the switch connected to switch control 2100 will send a signal to one switch control 2200 that will step through the available control methods. The first operation of the switch will cause the one switch control 2200 to switch to the +X axis control through the X+/− flip-flop circuit 2350. The second operation of the switch will cause the one switch control 2200 to switch back to the Y+/− flip-flop circuit 2300, which will switch to −Y control, enabling control of the −Y axis. The third operation of the switch will cause the one switch control 2200 to switch to the X+/− flip-flop circuit 2350, which will switch to the −X control, enabling control of the −X axis. A fourth operation of the switch will cause the one switch control 2200 to switch back to the default state, returning to the Y+/− flip-flop circuit 2300, which will switch back to the default state of +Y axis control. Further operation of the switch will cause the system to continue step through the control methods in the manner specified above.

Additional switches may be connected to switch control 2100 to enable additional features of the control system 2000. A switch may be connected to switch control 2100 to enable control of the Y lo/hi flip-flop circuit 2250. Operation of a switch connected to the Y lo/hi flip-flop circuit 2350 will enable the user the input higher values for the +Y control signal. In normal operation, the absolute value of the Y axis voltage signal is limited to a certain value. A user may wish to increase the limit to enable, for example, faster movement of a powered wheelchair when outdoors. If the switch connected to the Y lo/hi circuit 2250 is operated, the Y lo/hi circuit 2250 switches to the higher Y signal voltage limit value. A second operation of the switch will return the limit to the original, lower value, and additional operation of the switch will step through the signal voltage limits as described above.

A switch may also be connected to switch control 2100 to enable control of an external device connected to USP control 2700. Operation of a switch connected to USP control 2700 will provides the user with the ability to select between control of a powered wheelchair device and an external device connected to the control system 2000. A switch may also be connected to switch control 2100 to enable an emergency stop feature. If a switch for an emergency stop feature is operated, lock-out circuit 2800 supplies the device connected to control system 2000 with a neutral voltage, disabling user control until the control system is powered off and on.

Still with reference to FIG. 2, the lock-out circuit 2800 also contains a system monitor or “watch dog” feature that monitors the voltage signal output from all system components. If the voltage signal is outside of a specified range, the system monitor circuit will enable the lock-out circuit 2800 and will disable user control.

A further control system 2000 safety feature is the rapid deceleration inhibitor 2750. The rapid deceleration inhibitor 2750 prevents rapid deceleration via a rapid drop in signal from the +/−X or Y signal voltages due to the user operating a switch connected to switch control 2100. This feature prevents, for example, rapid braking or overly sharp turning due to the user switching from forward to reverse control, or from forward to left control, by operating a switch connected to switch control 2100 while the voltage signal from an input switch is at a high absolute value. The rapid deceleration inhibitor 2750 is engaged whenever any control switch, e.g., forward, forward plus, forward/reverse, or reverse in Y-axis common control 2600, is operated. When a control switch is operated, a switch in the Y-axis common control 2600 is opened, removing the resistor that enables a rapid bleed-off of the signal voltage out of the circuit. When a control switch is no longer operated, the switch is closed and the resistor is reconnected to the circuit, enabling a rapid bleed-off of the input signal voltage. In the Y-axis common control 2600 this prevents jerky motion and unwanted rapid deceleration.

A final voltage offset is applied to the signal voltage by the final offset circuit 2900. The offset to be applied is selectable by the user. The voltage offset allows the control system 2000 to be used with a variety of different devices. The voltage offset circuit 2900 can also be used to supply a reference voltage signal for a “Z-axis” necessary for the operation of certain devices.

With reference now to FIGS. 1A and 3, with specific reference to FIG. 3, an exemplary embodiment of the input circuitry 300 for control system 1000 is depicted. A signal voltage comes from tilt transducers 1050a and 1050b. Signal orientation selectors 1150a and 1150b provide for the inversion or switching of input signals from transducers 1050a and 1050b. In this embodiment, the signal orientation selectors 1150a and 1150b are a set of dip switches that allow a user or technician to customize the control input by selecting the signal path based on user needs. The orientation & inversion circuits 1100a and 1100b provide a user with the ability to change the orientation of the tilt transducers to suit the user. The signal voltage continues to signal conditioning circuits 1950a and 1950b.

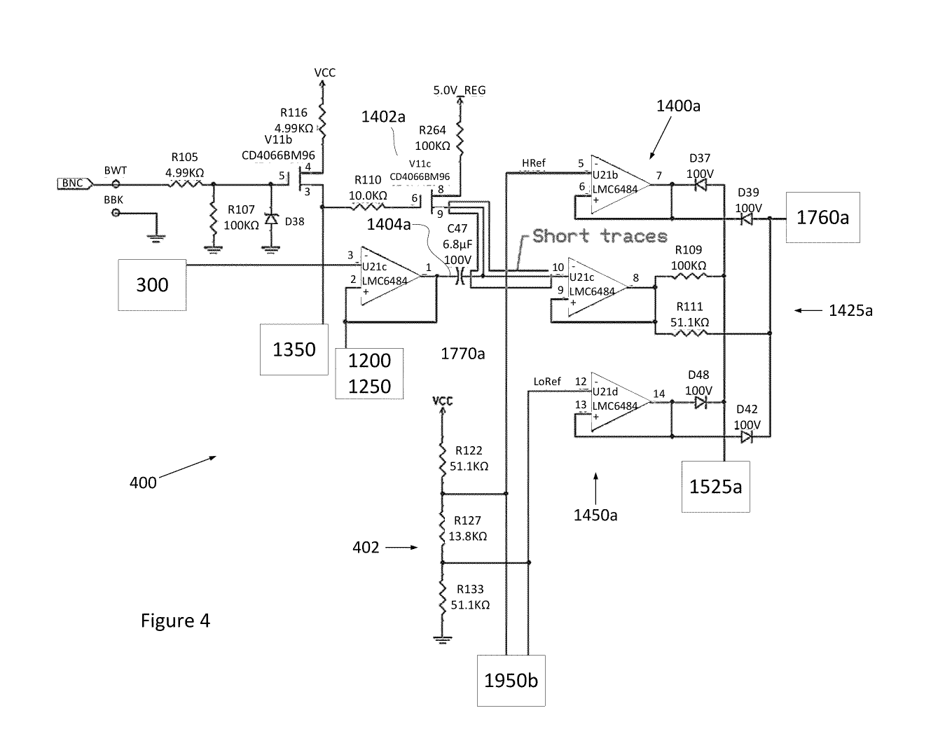

For FIGS. 4, 8 and 9, reference is made to conditioning circuit 1950a, however, similar or identical circuits are found in conditioning circuit 1950b. With reference now to FIGS. 1 and 4, with specific reference to FIG. 4, buffering and limiting circuitry 400 is depicted. An input signal for system power comes from latch and delay circuitry 1350. This input signal opens the solid state switch 1402a. When the system is powered on, and the switch 1402a is closed, a signal offset is stored in the capacitor 1404a. The input signal from buffer 1770a may be at, for example 2.4 volts. A neutral voltage of 5 volts is supplied when switch 1402a is closed. After a specified time-out period of 0-8 seconds, the switch 1402a opens, and the voltage offset is stored in the capacitor 1404a. There is very little voltage leakage in capacitor 1404a and buffer 1770a, which may be, for example, an LMC 6484 quad-rail precision amplifier. This enables the capacitor 1404a to hold its offset voltage for at least 24 hours. This voltage offset adjusts the input signal from the input circuitry 300 to compensate for however far off the input signal voltage is from the neutral voltage. The voltage offset allows the control system 1000 to be operated normally even if the tilt transducer 1050a or 1050b are not positioned in a perfect orientation on the user. The user may re-set the offset held in the capacitor 1404a by resetting the control system 1000. The voltage offset signal from buffer 1770a and capacitor 1404a is sent to both over-range limiter 1200 and over-rate limiter 1250. Signal limiters 1400a and 1450a limit the input signal. The reference for the signal limiters 1400a and 1450a is provided from voltage reference 402, and the input voltage is sent through buffer and limiter 1425a. The value limited signal is sent to both buffer 1760a and null width generator 1525a.

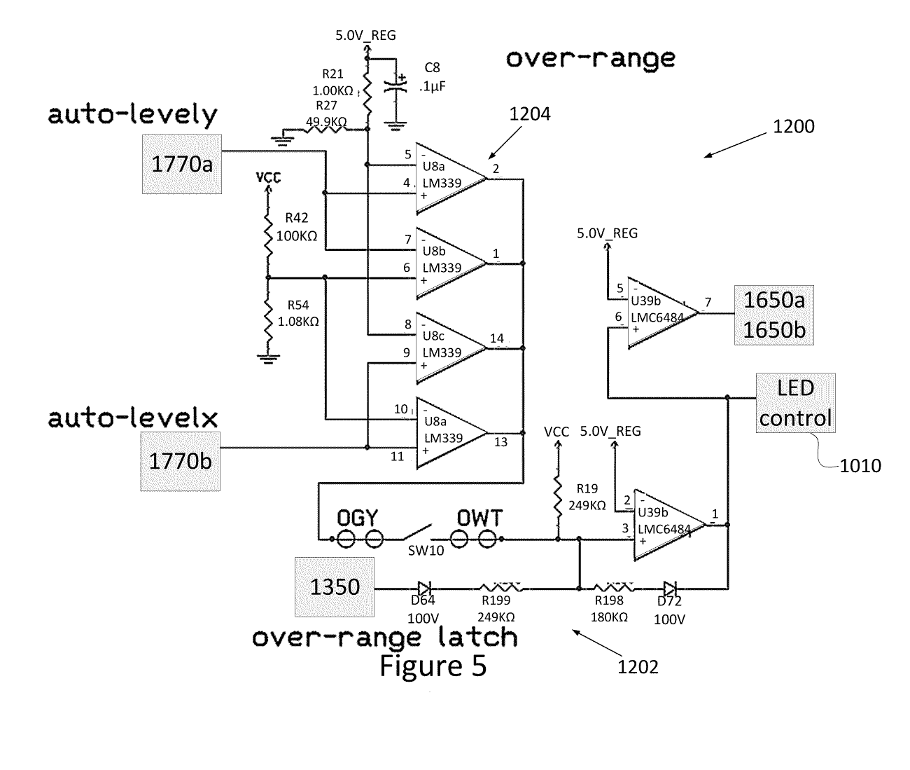

With reference now to FIGS. 1A and 5, with specific reference to FIG. 5, over-range limiter 1200 is depicted. An input voltage signal is sent to over-range limiter 1200 from buffers 1770a and 1770b for the Y and X input voltage signals respectively. Comparators 1204 check the input voltage signals against an upper and lower voltage limit. If the input voltage exceeds the upper or lower limit, over-range latch 1202 latches. When latched, lockout circuits 1650a and 1650b are activated, and a visual notification of an over-range is shown to the user through LED control 1010.

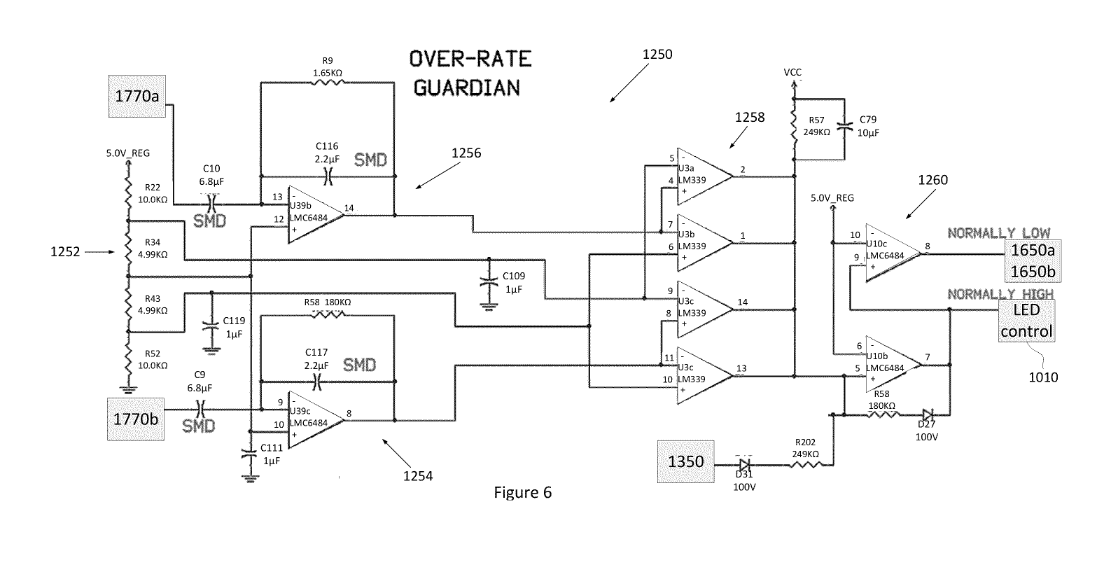

With reference now to FIGS. 1A and 6, with specific reference to FIG. 6, over-rate limiter 1250 is depicted. Input voltages for Y and X input are sent from buffers 1770a and 1770b respectively. Reference voltages are provided at reference voltage circuitry 1252. If the rate through op amps and R/C circuits 1256 and 1254 is determined by comparators 1258 to be greater than the reference voltages 1252, then a signal is sent from op amp 1260 to lockdown circuits 1650a and 1650b to return the voltage signal to neutral, overriding user control. A visual notification of an over-rate state is shown to the user through LED control 1010.

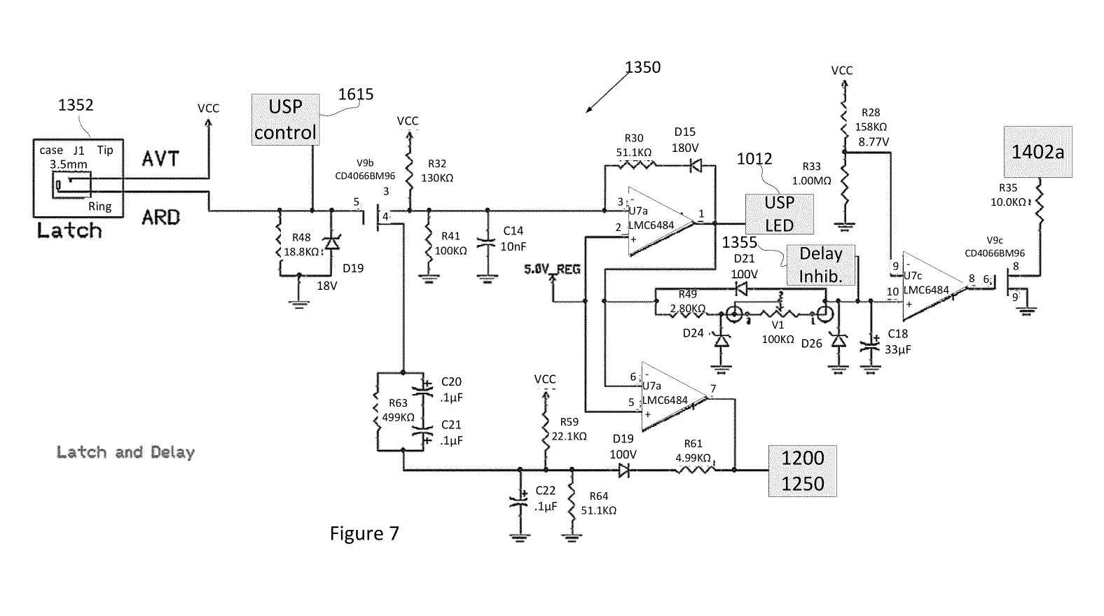

With reference now to FIGS. 1A and 7, with specific reference to FIG. 7, latch and delay circuit 1350 is depicted. The enable delay function provides a selectable delay time period ranging from 0 to 7 seconds. The delay period commences when the user activates a mode switch connected at connection port 1352, and ends when an indicator LED darkens. The time delay allows a user an opportunity to comfortably and naturally position their head or other body member(s) before the system defines the user's neutral position. The higher the setting for the delay, the greater the time delay prior to tilt transducer activation. The switch is used to activate the system 1000 and to enable control of an external device in the USP port 1615. If the switch is held closed for 3 seconds, control of the USP is activated. The user is given a visual notification of USP control at USP LED 1012. The latch and delay circuit 1350 also delays the activation of over-range limiter 1200 and over-rate limiter 1250. Delay inhibitor 1355 disables the delay when use of USP 1615 is activated. The signal from the latch and delay circuit is sent to the switch 1402a to enable user control.

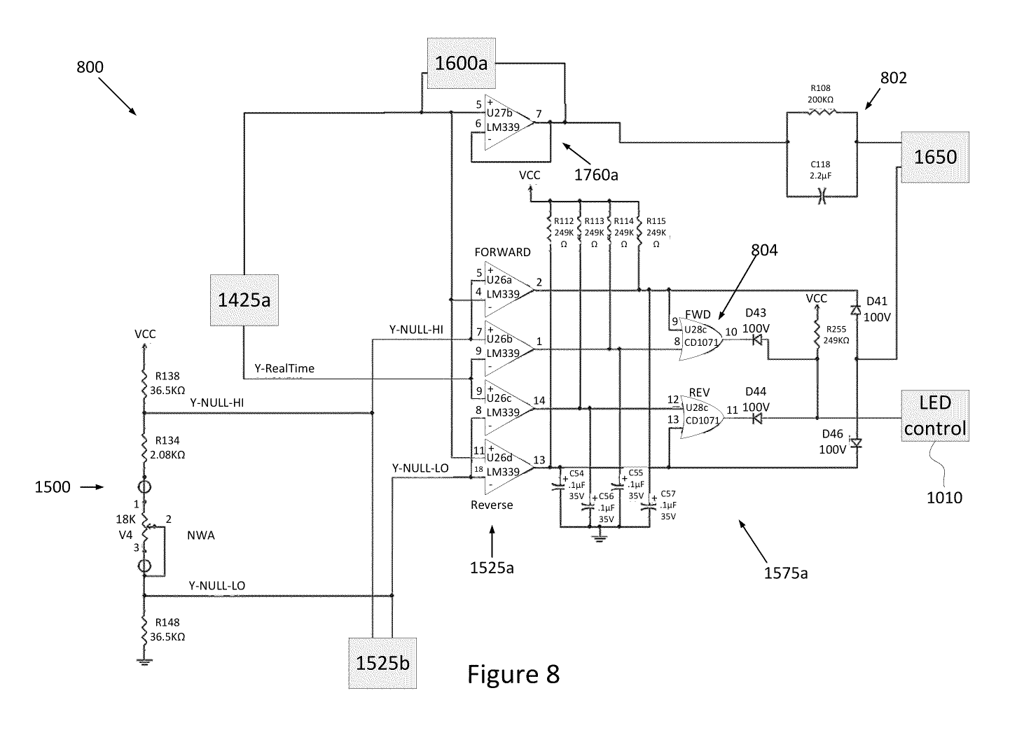

With reference now to FIGS. 1A and 8, with specific reference to FIG. 8, conditioning circuitry 800 is depicted. Conditioning circuitry 800 comprises null width adjustment 1500, null voltage generator 1525a, attack/decay conditioner 1575a, buffer 1760a, and R/C circuit 802. Null width adjustment 1500 allows for an adjustable voltage limit for a null or neutral voltage. The upper and lower limit set at null width adjustment 1500 is used by null width generator 1525a to determine if the input signal from buffer 1425a is within the specified null voltage limit. The null voltage is useful if the user experiences tremors or cannot maintain a fixed center. Attack/decay conditioner 1575a provides for a rapid return to neutral to prevent oversteering. Or gates 804 activate a visual signal through LED control 1010 if the input signal voltage is determined to be centered. Real time signal control is provided by real-time input circuitry 1600a to the USP module.

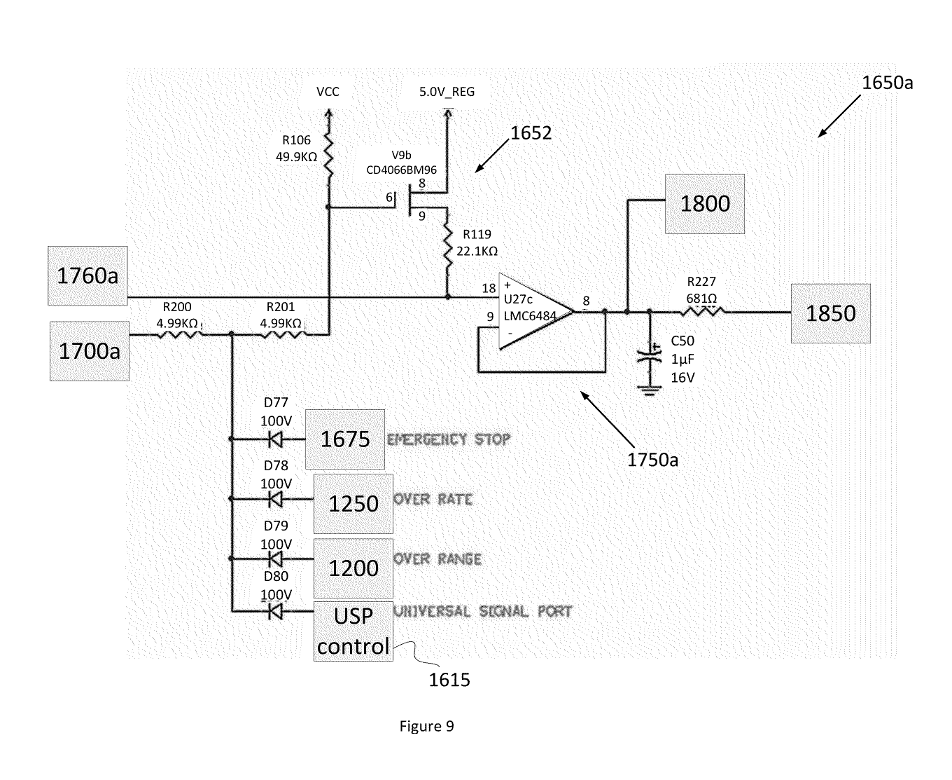

With reference now to FIGS. 1A and 9, with specific reference to FIG. 9, lockout circuit 1650a is depicted. If a signal is sent from attack/decay conditioner 1575a, emergency stop circuit 1675, over-rate limiter 1250, over-range limiter 1200, or if the USP control 1615, switch 1652 is opened and a neutral voltage is sent to the control output. If a signal is not sent from one of the aforementioned circuits, the input signal voltage from buffer 1760a continues through buffer 1750a and is monitored by watch dog circuit 1800 and is proportioned at X/Y proportioner 1850.

Referring now to both FIGS. 8 and 9, the null width circuit 1525a, attack/decay conditioner 1575a, and lockout circuit 1650a are discussed in more detail. The set of comparators 1525 compares the adjustable null voltage from null width adjustment 1500 to determine if the input signal is within the specified voltage. If the signal is “centered” or within the null width or “neutral zone,” the user is given a visual indication and the switch 1652 is closed. While the switch 1652 is closed the control system outputs a neutral voltage to disable user control while the input is centered in the neutral zone. Any input signal voltage applied while in the neutral zone, but not exceeding the specified null width voltage, is stored in the R/C circuit 802. The capacitor and resistor that make up the R/C circuit 802 will store and the slowly add or “bleeds off” the stored voltage into the input signal voltage to enable a more responsive control of the device connected to the control system 1000 until the stored voltage is reduced to 0 volts. The rate of the signal “bleed” into the input voltage is determined by the difference between the input voltage and the stored voltage in the R/C circuit 802; a greater difference will result in a faster addition of the stored voltage to the input signal voltage. The advantage to this configuration is that there is a full range of signal and no input signal is lost. The combination of the null width generator 1525a and the R/C circuit 802 provides for very smooth control by the control device 1000; it prevents jerky acceleration and turning of a powered wheelchair type device. Another important feature of this portion of the system is the rapid “snap back” or return to center of the input signal voltage once the user has returned the tilt transistor 1050a to its centered position. Once the input signal voltage returns to center as determined by the comparators in null width generator 1525a, the switch 1652 is again closed and the neutral 5 volt signal is output by the system. Any stored voltage in the R/C circuit 802 is rapidly bled off. The return to neutral and rapid bleed off of the stored voltage provides for faster stopping, no oversteering, and helps prevent fishtailing of a powered wheelchair device. It should be noted that the similar circuit in signal conditioner 1950b provides for a more rapid bleed off of the stored voltage in the corresponding R/C circuit to provide for more responsive turning. Furthermore, this configuration allows for even a partial tilt of the tilt transducer 1050a to translate into a full control signal, further improving responsiveness and control. The neutral zone provided by the null width generator 1525a also allows a user to center the tilt transducers 1050a and 1050b for a period of time, for example 5-10 seconds, to access menu options or additional functions in the powered wheelchair connected to control system 1000.

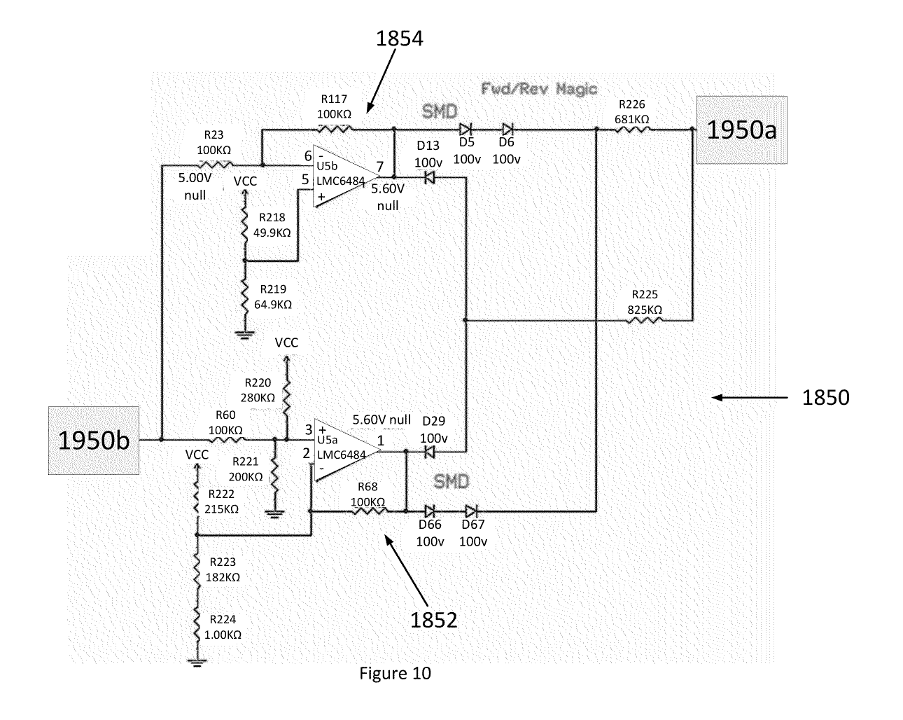

With reference now to FIGS. 1A and 10, with specific reference to FIG. 10, X/Y proportioner 1850 is depicted. The Y input voltage signals from signal conditioners 1950a is conditioned proportionally by conditioners 1852 and 1854. For example, if the signal voltage for control of the Y axis is in a high positive state for a high rate of forward motion, the X/Y proportioner 1850 will condition the signals for the Y signal voltage to prevent the signal voltage for the Y axis from also being in a high positive state. The Y input signal is conditioned non-linearly as a function of the X input signal, and the X input signal is not changed or reduced. This proportional conditioning prevents a device controlled by the system 1000 from “fishtailing” or performing other undesirable or unsafe actions. The conditioned signals are then returned to signal conditioners 1950a and 1950b to be sent to Y and X signal output.

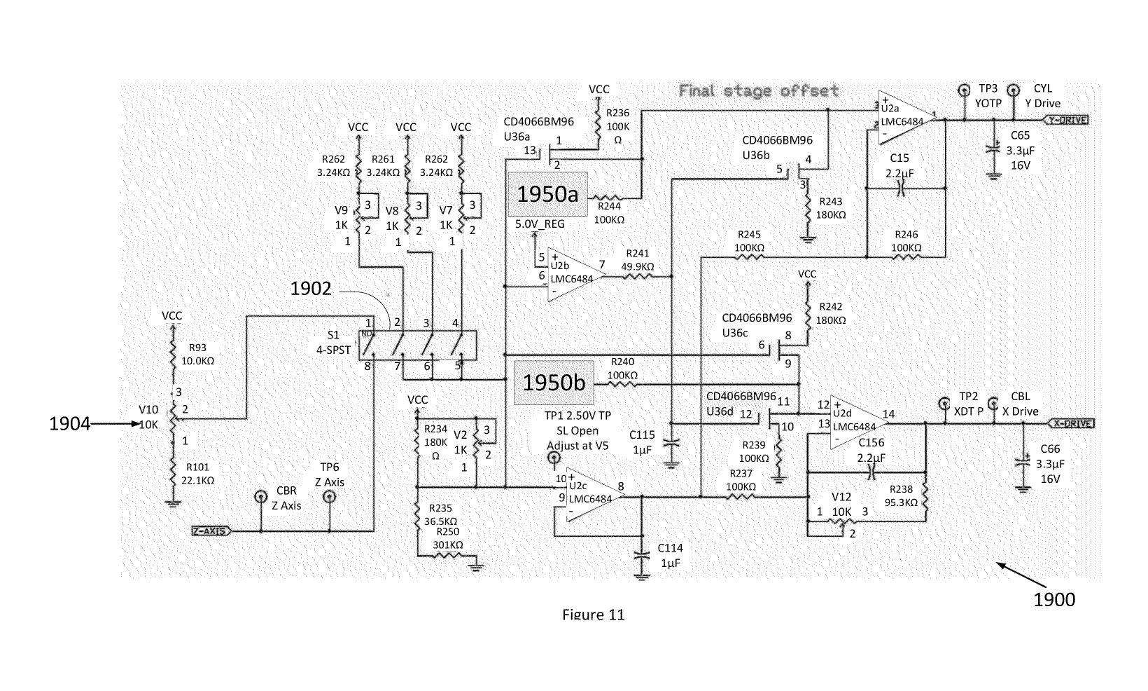

With reference now to FIGS. 1A and 11, with specific reference to FIG. 11, final offset and Z-axis circuit 1900 is depicted. The fully conditioned input voltage signals from signal conditioners 1950a and 1950b, Y and X axis respectively, are modified by any specified voltage offset. The voltage offset is selected by using dip switches 1902. If a Z-axis output is needed for operation of a particular device, an adjustable reference voltage can be supplied to Z-axis output 1904 by selecting the corresponding dip switch 1902. The input voltage signals are sent to Y-drive and X-drive outputs after any offsets have been applied as selected through dip switches 1902.

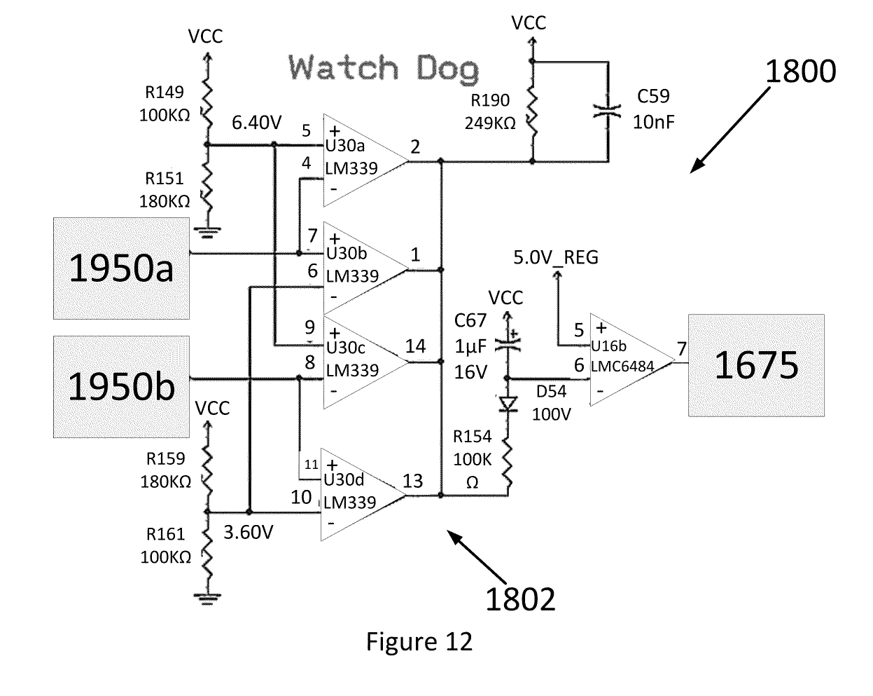

With reference now to FIGS. 1A and 12, with specific reference to FIG. 12, watch dog circuit 1800 is depicted. Watch dog circuit 1800 is a system monitoring circuit that receives input from signal conditioners 1950a and 1950b. If the signal from the conditioners is determined to exceed upper and lower limits by comparators 1802, a signal is sent to emergency stop circuit 1675 to halt user control.

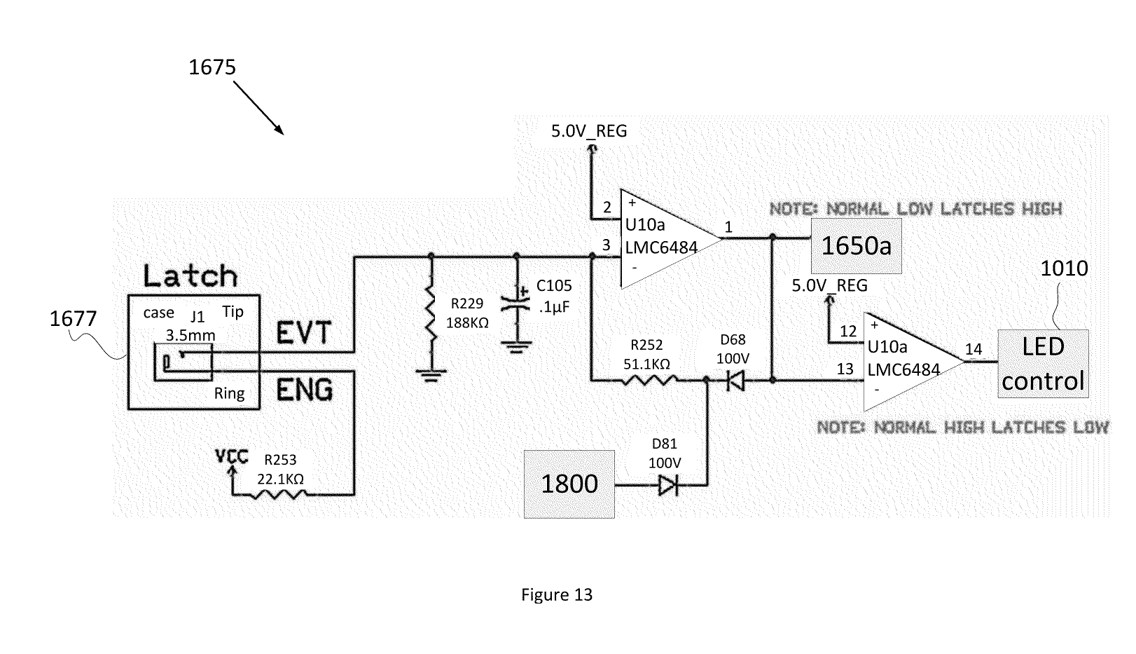

With reference now to FIGS. 1A and 13, with specific reference to FIG. 13, emergency stop circuitry 1675 is depicted. Emergency stop circuitry 1675 allows for immediate shut down of the control system 1000 through the use of a switch connected to control port 1677 or from an input signal from watch dog circuit 1800. In one embodiment, the port 1677 provides a ⅛ inch (3.5 mm) plug receptacle used to deactivate the system by either the user or a caregiver. The control system 1000 must be completely powered down to reset the emergency stop circuitry 1675. Any commonly used mode or reset switch, such as a red Jelly Bean switch by Able Net® or similar switch could be used. If the switch connected to port 1677 is pressed or if a signal is received from the watch dog circuit 1800, the lockout circuits 1650a and 1650b are activated. A visual signal of an emergency stop state is sent to the user through LED control 1010.

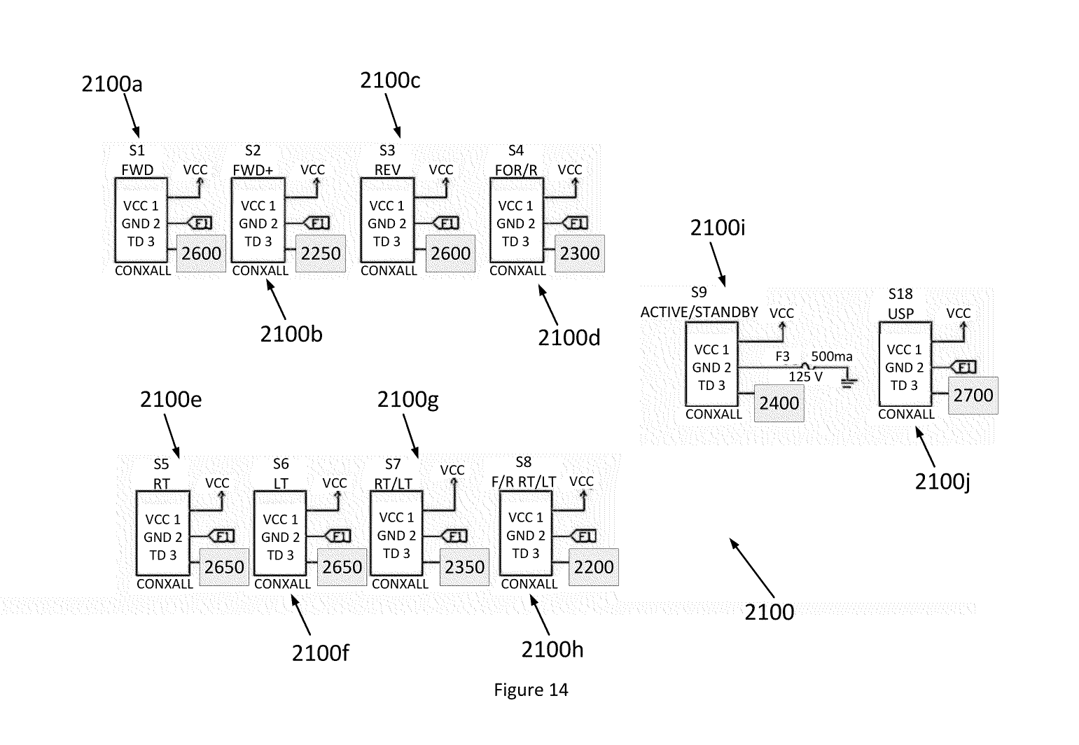

With reference now to FIGS. 2 and 14, with specific reference to FIG. 14, switch control 2100 is depicted. Switch control 2100 consists of a plurality of control ports 2100a-2100j. The control ports allow a user or caregiver to connect one or more switches to enable selective control of a device connected to the control system 2000. In a first embodiment, switches will be connected to forward port 2100a, reverse port 2100c, right port 2100e, left port 2100f, and active/standby port 2100i. In a second embodiment, switches are connected to forward/reverse port 2100d, right/left port 2100g, and active standby port 2100j. In a third embodiment, switches are connected to one switch control port 2100h and active/standby port 2100i. Other combinations of switch connectivity are also possible. In any switch configuration, switches may also be connected to forward+ port 2100b and to USP control port 2100j.

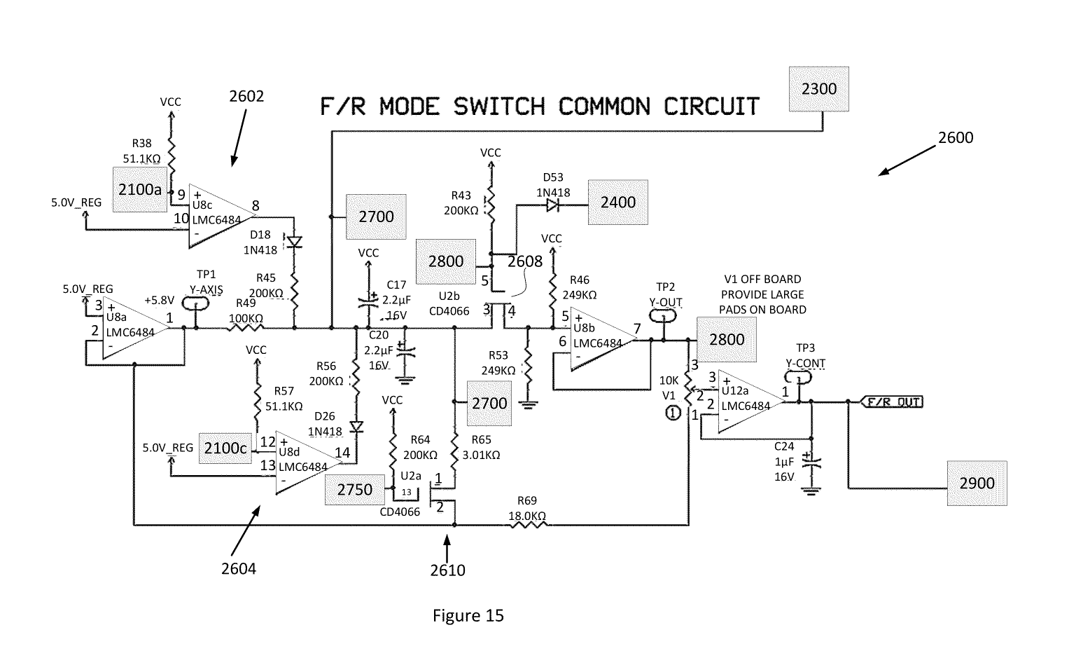

With reference now to FIGS. 2 and 15, with specific reference to FIG. 15, Y-axis common control circuit 2600 is depicted. An input signal voltage is provided from switches 2100a, 2100c, or from the flip flop circuit 2300. User operation of a switch connected to forward port 2100a from switch control 2100 is initially conditioned at op amp 2602. User operation of a switch connected to reverse port 2100c from switch control 2100 is initially conditioned at op amp 2604. The input signal voltage from switches 2100a or 2100c is increased or decreased, “pulled up or down”, by the high side and low side resistors on the circuit. Rapid deceleration inhibitor 2750 closes switch 2610 when any switch connected to one switch control 2100 is open and not being operated by the user, enabling a rapid bleed-off of the input signal voltage. This rapid bleed-off of the input signal voltage prevents rapid deceleration or jerky control by providing a rapid bleed off of the input signal through a 3.01K ohm resistor on the circuit. USP control 2700 is connected to Y-axis common control 2600 so input voltage signals may be sent to an USP device connected to USP control 2700 If the system monitoring portion of the lock-out module 2800 determines that a system malfunction has occurred, or if the emergency stop portion of the lock-out module has been activated, the switch 2608 is opened so that only a neutral voltage is output by the Y-axis common control 2600, locking out user control. Activation of the active/standby module 2400 will also open the switch 2608. Conditioned input voltage signals are sent to final offset module 2900 for final voltage offset.

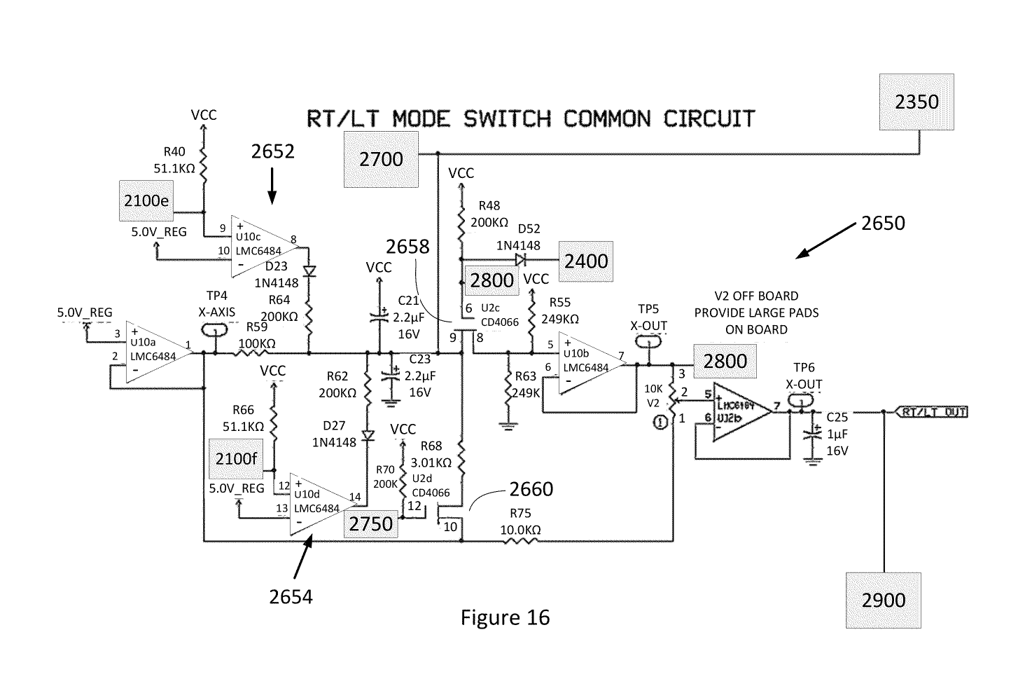

With reference now to FIGS. 2 and 16, with specific reference to FIG. 16, X-axis common control circuit 2650 is depicted. An input signal voltage is provided from switches 2100e, 2100f, or from flip-flop circuit 2350. User operation of a switch connected to right control port 2100e from switch control 2100 is initially conditioned at op amp 2652. User operation of a switch connected to left control port 2100f from switch control 2100 is initially conditioned at op amp 2654. The input signal voltage from switches 2100e or 2100f is increased or decreased, “pulled up or down”, by the high side and low side resistors on the circuit. Rapid deceleration inhibitor 2750 closes switch 2610 when any switch connected to one switch control 2100 is open and not being operated by the user, enabling a rapid bleed-off of the input signal voltage. This rapid bleed-off of the input signal voltage prevents rapid deceleration or jerky control by providing a rapid bleed off of the input signal through a 3.01K ohm resistor on the circuit. USP control 2700 is connected to X-axis common control 2650 so input voltage signals may be sent to an USP device connected to USP control 2700. If the system monitoring portion of the lock-out module 2800 determines that a system malfunction has occurred, or if the emergency stop portion of the lock-out module has been activated, the switch 2658 is opened so that only a neutral voltage is output by the X-axis common control 2650, locking out user control. Activation of the active/standby module 2400 will also open the switch 2658. Conditioned input voltage signals are sent to final offset module 2900 for final voltage offset.

A difference between the control circuit 1000 in FIG. 1 and the control circuit 2000 in FIG. 2 is that the real time input module 1600a in control system 1000 is connected to a USP port and provides a real time voltage input signal to a device connected to the port while the control system 2000 cannot provide a real time input signal. The response rate of the voltage input signal in the control system 2000 is limited by the R/C circuits in depicted in FIGS. 15 and 16 which is set by the physical limitations of the R/C circuits.

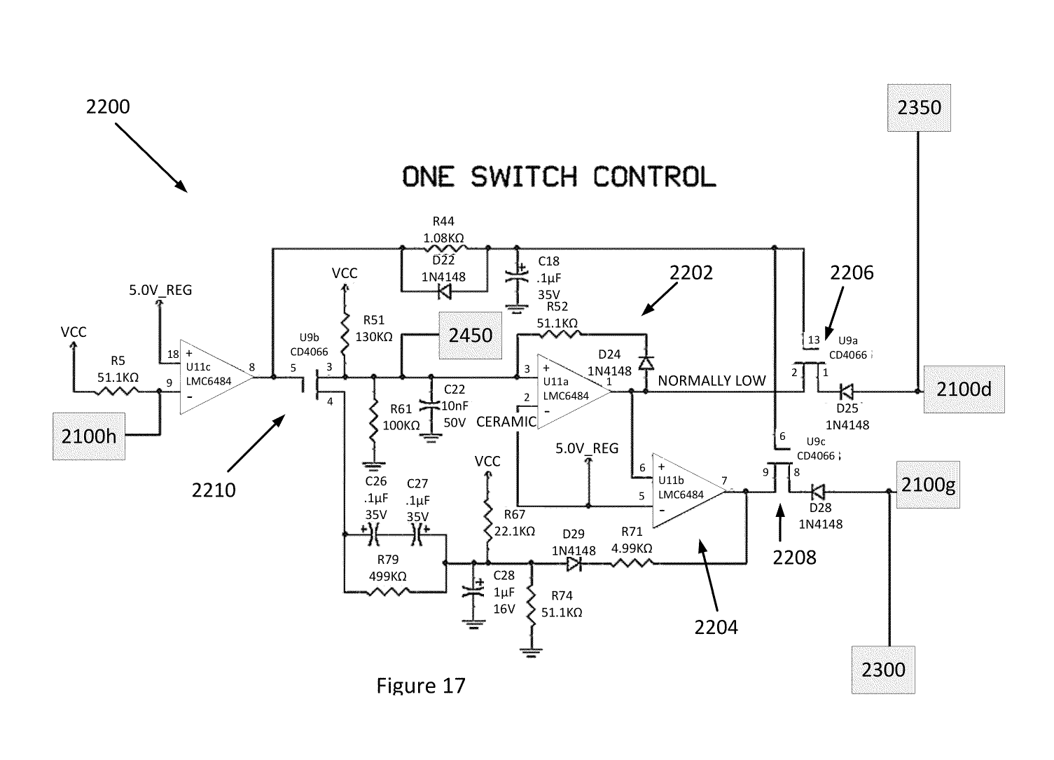

With reference now to FIGS. 2 and 17, with specific reference to FIG. 17, one switch control circuit 2200 is depicted. When a signal from the one switch control port 2100h is received, switches 2206, 2208, and 2210 are opened. The first operation of the one switch 2100h will cause a signal to be sent through op amp 2204 to Y+/− flip-flop circuit 2300 as though a switch connected to forward/reverse port 2100d had been operated. A second operation will cause a signal to be sent through op amp 2202 to X+/− flip-flop circuit 2300 as though a switch connected to left/right port 2100g had been operated. The one switch control flip-flop circuit 2200 is reset from a signal from flip-flop reset circuit 2450. The functionality of one switch control circuit 2200 allows a user to step through X and Y inputs through the use of a single input switch 2100h, providing users with limited body member control the ability to have full operation of a powered wheelchair device controlled by control system 2000.

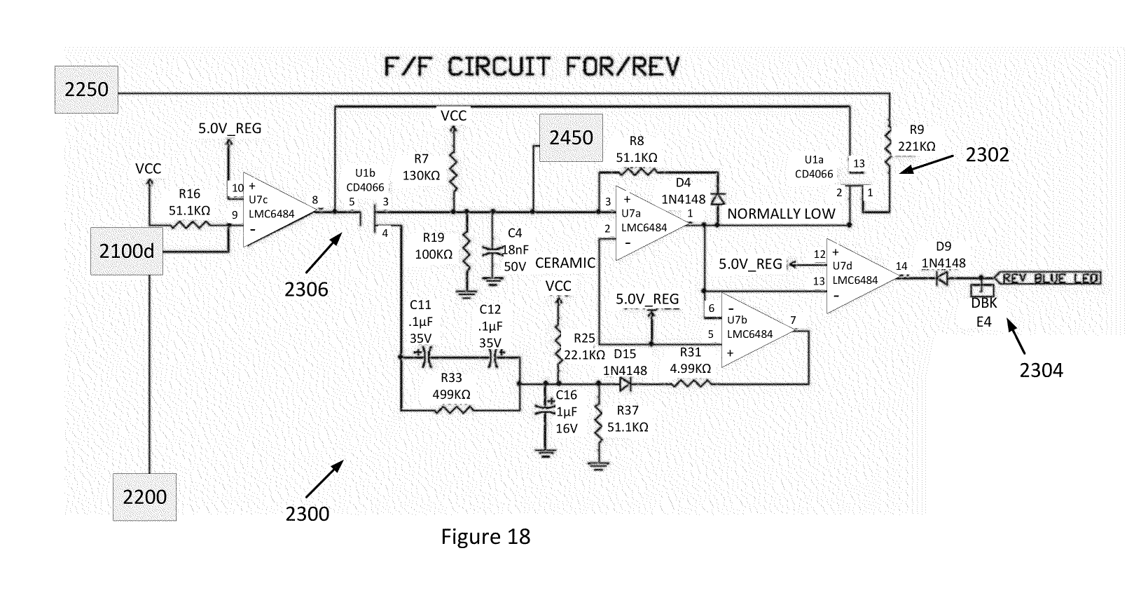

With reference now to FIGS. 2 and 18, with specific reference to FIG. 18, a Y+/− flip-flop circuit 2300 is depicted. The Y+/− flip-flop circuit 2300 allows a user to select from either +Y-axis or −Y-axis control through the operation of switch 2100d or from a switch connected to one switch control 2200. Switches 2306 and 2302 are opened in response to the signal from port 2100d, providing the user with alternating +Y-axis and −Y-axis control. If the circuit 2300 is providing −Y-axis control, the user is given is visual indication through LED 2304. The conditioned signal is sent to Y-axis common control circuit 2600.

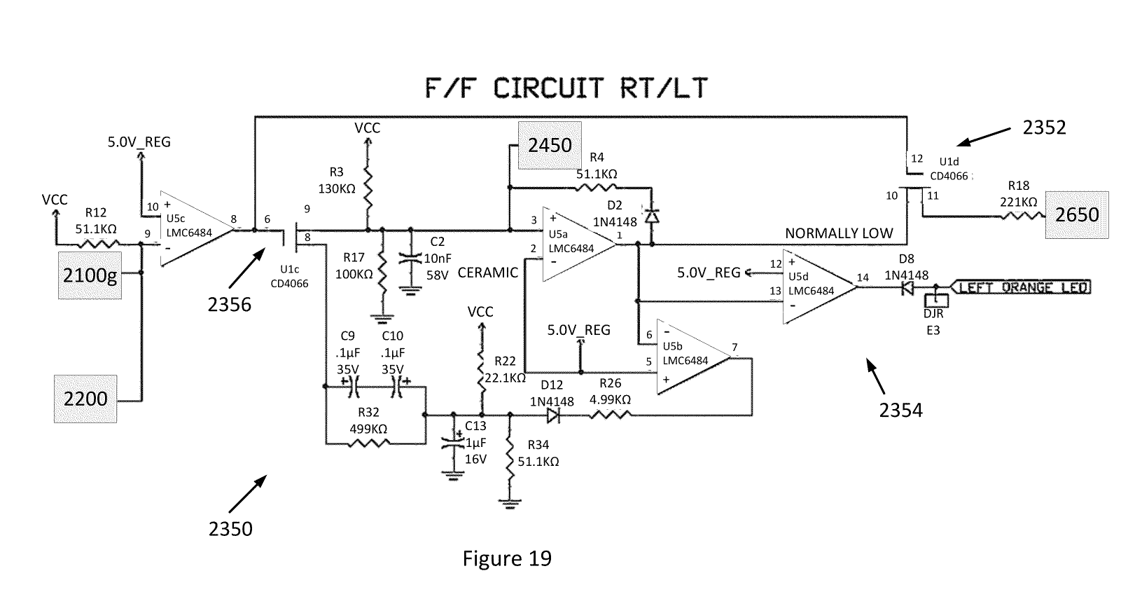

With reference now to FIGS. 2 and 19, with specific reference to FIG. 19, a X+/− flip-flop circuit 2350 is depicted. The X+/− flip-flop circuit 2350 allows a user to select from either +X-axis or −X-axis control through the operation of switch 2100g or from a switch connected to one switch control 2200. Switches 2356 and 2352 are opened in response to the signal from port 2100d, providing the user with alternating +X-axis and −X-axis control. If the circuit 2350 is providing −X-axis control, the user is given is visual indication through LED 2304. The conditioned signal is sent to X-axis common control circuit 2650.

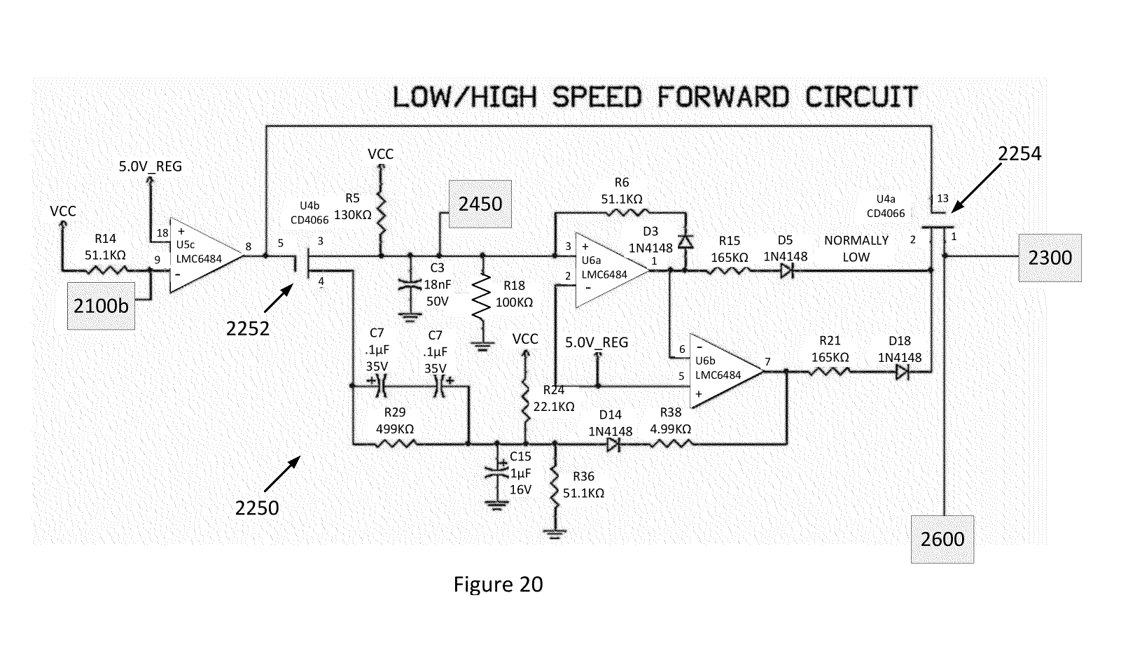

With reference now to FIGS. 2 and 20, with specific reference to FIG. 20, a Y lo/hi flip-flop circuit 2250 is depicted. The Y lo/hi flip-flop circuit 2250 allows a user to select from either a low speed or high speed Y-axis control through the operation of switch 2100b. Switches 2256 and 2252 are opened in response to the signal from port 2100d, providing the user with alternating high and low speed Y-axis control. The conditioned signal is sent to Y-axis common control circuit 2600. High speed Y-axis control increases the maximum input signal voltage, allowing a user a higher maximum Y-axis signal value, thus providing for faster movement of a device controlled by control system 2000.

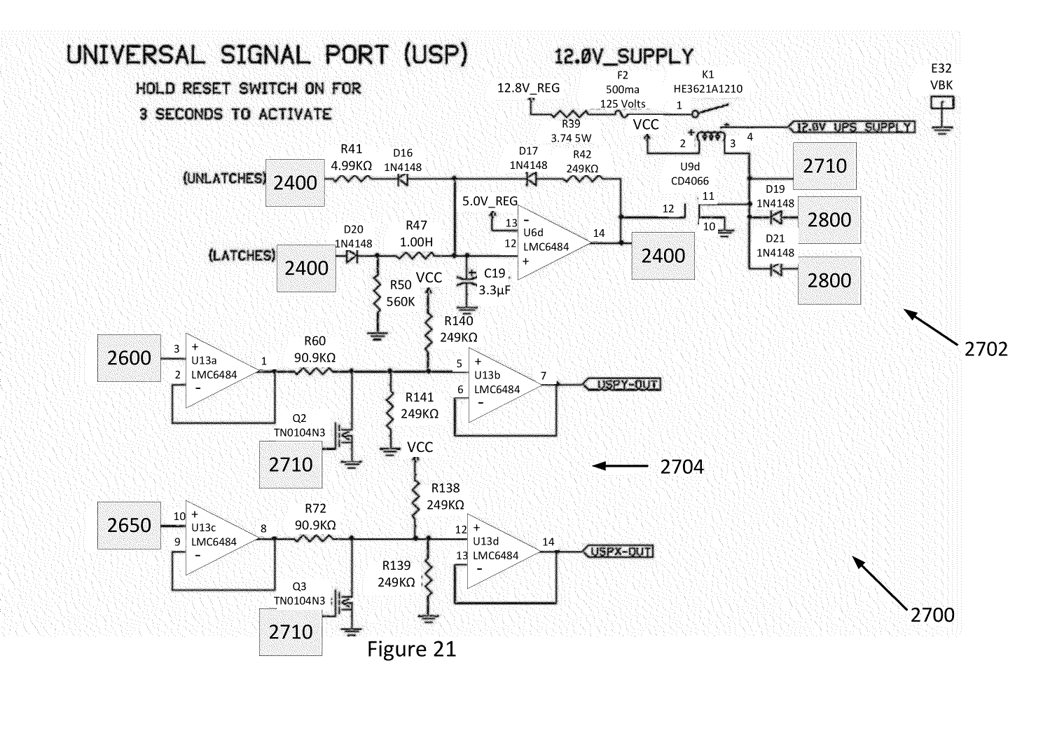

With reference now to FIGS. 2 and 21, with specific reference to FIG. 21, USP control 2700 is depicted. USP control 2700 provides for user control of a device connected to the universal signal port. Power control circuitry 2702 provides power to the device connected to the USP control output 2704. Input control signal voltages from Y-axis common control 2600 and X-axis common control 2650 also provide control signal voltages for the device connected to the USP control 2700. Active/standby circuit 2400 is used to both enable and disable USP control 2700. USP control is also connected to lock-out circuitry 2800 to provide protection against system faults. Power is provided to an USP device connected to the USP port through power connection 2710.

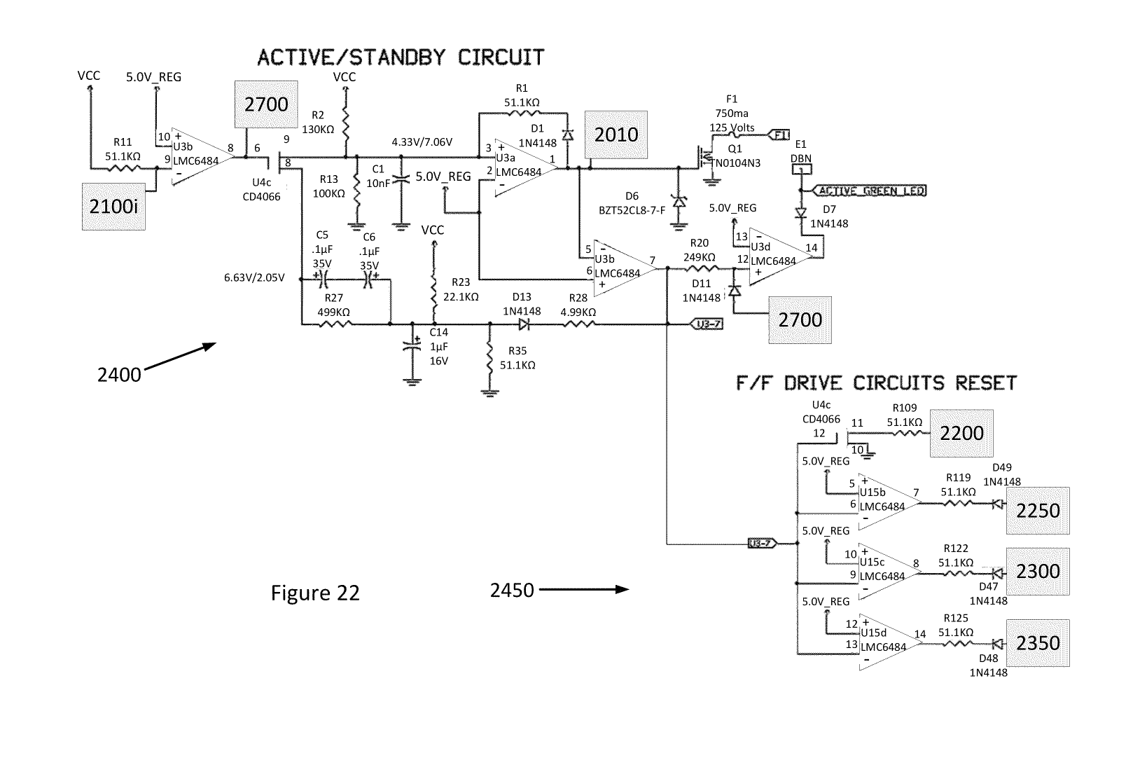

With reference now to FIGS. 2 and 22, with specific reference to FIG. 22, active/standby circuit 2400 and flip-flop reset circuit 2450 are depicted. The control system 2000 is powered on when a switch connected to port 2100i is operated. If the switch 2100i is held for a period of time, three seconds for example, then control of USP control 2700 is activated. A delay of 0-7 seconds may be applied before a user may begin control of either the USP control 2700 or of input circuits 2010 which comprise Y-axis common control 2600 and X-axis common control 2650 and also disarms the rapid deceleration inhibitor 2750 when input signals are received for forward/reverse or left/right motion. When the control system 2000 is powered on, one switch control 2200, Y lo/hi flip-flop 2250, Y+/− flip-flop 2300, and X+/− flip flop 2350 are reset to their default states.

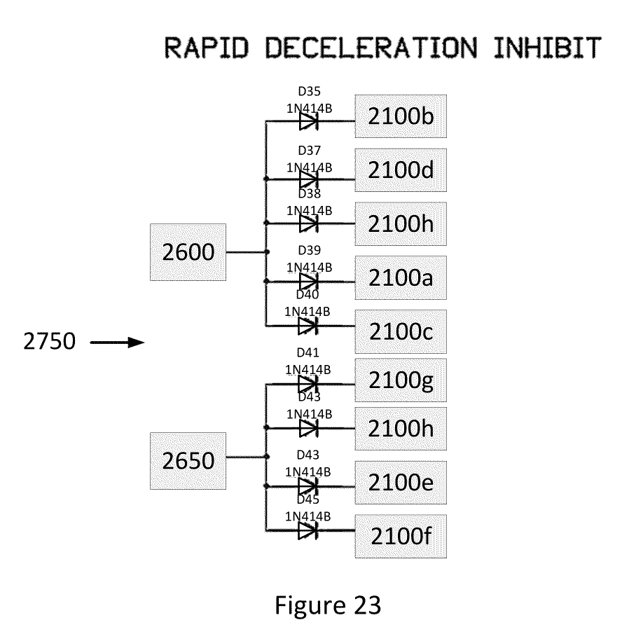

With reference now to FIGS. 2 and 23, with specific reference to FIG. 23, rapid deceleration inhibitor 2750 is depicted. If any switch 2100a, 2100b, 2100c, 2100d, 2100e, 2100f, 2100g, or 2100h connected to switch control 2100 is operated, a signal is sent from rapid deceleration inhibitor 2750 to corresponding Y-axis common control 2600 or X-axis common control 2650 to prevent rapid deceleration or turning due to input switching.

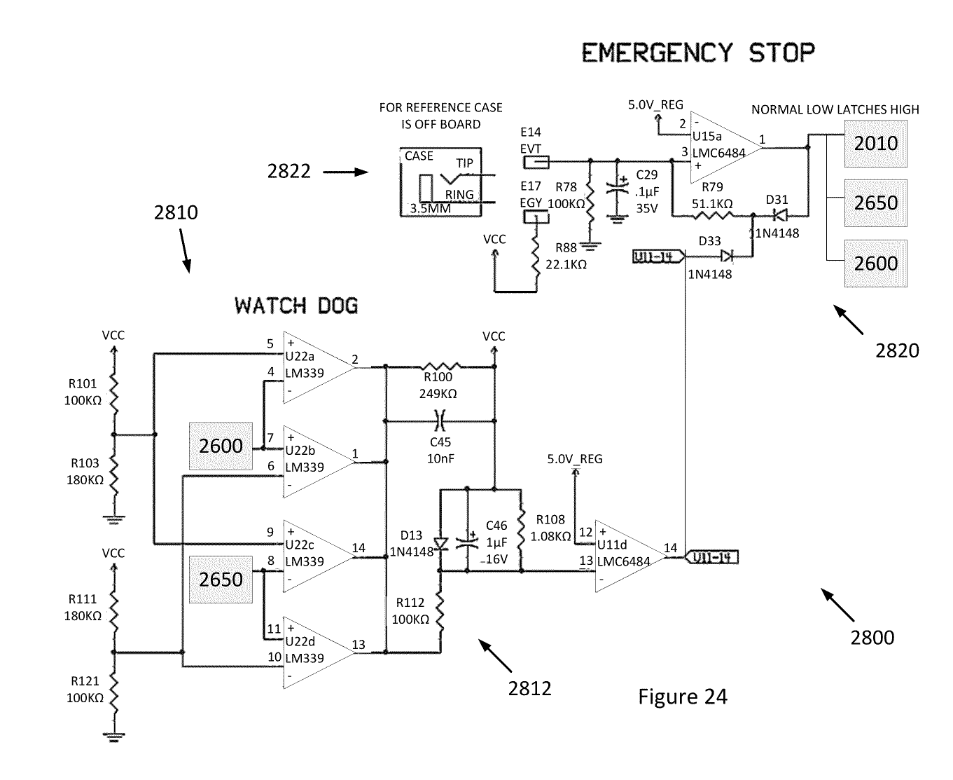

With reference now to FIGS. 2 and 24, with specific reference to FIG. 24, lock-out circuit 2800 is depicted. Watch dog circuit 2810 is a system monitoring circuit that receives input from Y-axis common control 2600 and X-axis common control 2650. If the signal from the common controllers is determined to exceed upper and lower limits by comparators 2812, a signal is sent to emergency stop circuit 2820 to halt user control. Emergency stop circuitry 2820 allows for immediate shut down of the control system 2000 through the use of a switch connected to control port 2822 or from an input signal from watch dog circuit 2810. In one embodiment, the port 2822 provides a ⅛ inch (3.5 mm) plug receptacle used to deactivate the system by either the user or a caregiver. The control system 2000 must be completely powered down to reset the emergency stop circuitry 2820. Any commonly used mode or reset switch, such as a red Jelly Bean switch by Able Net® or similar switch could be used. If the switch connected to port 2822 is pressed or if a signal is received from the watch dog circuit 2810, a signal is sent to Y-axis common control 2600 and X-axis common control 2650 opening a switch and causing a neutral voltage control signal to be output. A visual signal of an emergency stop state is sent to the user through LED control 2010.

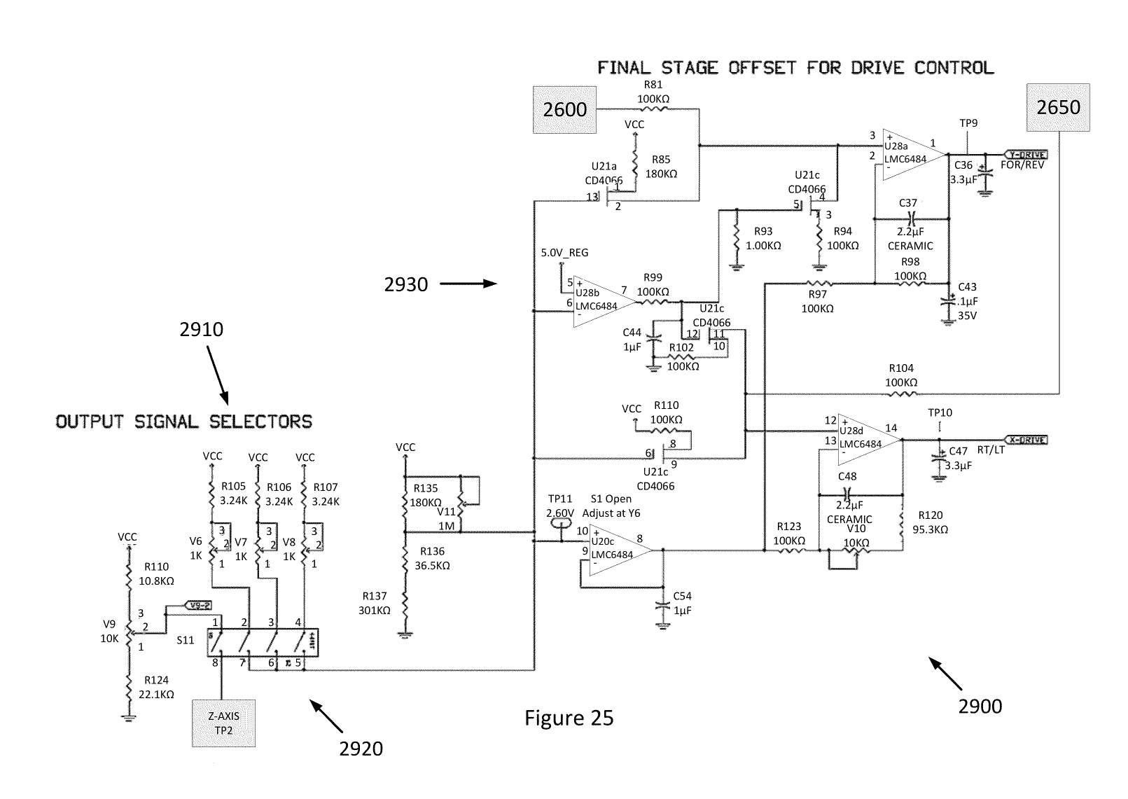

With reference now to FIGS. 2 and 25, with specific reference to FIG. 25, final offset and Z-axis circuit 2900 is depicted. The fully conditioned input voltage signals from Y-axis common control 2600 and X-axis common control 2650, are modified by any specified voltage offset. The voltage offset is selected by using dip switches in output signal selector circuit 2910. If a Z-axis output is needed for operation of a particular device, an adjustable reference voltage can be supplied to Z-axis output 2920 by selecting the corresponding dip switch. The input voltage signals are sent to Y-drive and X-drive outputs after any offsets have been applied in offset circuitry 2930 as selected through output signal selector 2910.

While specific apparatus and method have been disclosed in the preceding description, it should be understood that these specifics have been given for the purpose of disclosing the principles of the present invention and that many variations thereof will become apparent to those who are versed in the art. Therefore, the scope of the present invention is to be determined by the appended claims and their respective recitations.

What is claimed is:

1. A method which comprises:
a) actuating a switch;
b) disabling control of a device in response to the actuation of the switch;
c) selectively actuating a first transducer;
d) generating a first control signal in response to the actuation of the first transducer;
e) storing a first voltage offset proportional to the first control signal generated by the actuation of the first transducer;
f) enabling control of the device;
g) selectively increasing or decreasing the voltage of the first control signal; and
h) operating the device using the first control signal from the first transducer wherein the first control signal is modified by the first voltage offset.

2. The method of claim 1 wherein the voltage of the first control signal may be selectively inverted.

3. The method of claim 1 wherein operation of the device by the first control signal is prevented if the value of the first control signal exceeds a specified voltage.

4. The method of claim 1 wherein the voltage of the first control signal may be automatically adjusted based on detected rapid changes in the voltage of the first control signal.

5. The method of claim 1 wherein operation of the device is prevented unless the voltage of the first control signal exceeds a specified null width range.

6. The method of claim 1 wherein further actuation of the switch may enable or disable real-time control of an external device.

7. The method of claim 1 wherein a limit on the rate-of-change of the voltage for the first control signal may be set.

8. The method of claim 1 wherein the method further comprises:
a) increasing or decreasing the modified voltage of the first control signal by a unique voltage selected from a set of unique voltages; and
b) enabling or disabling the output of an additional unique control signal if an additional control signal is required to operate to the device.

9. The method of claim 1 wherein the method further comprises:
a) selectively actuating a second transducer;
b) generating a second control signal in response to the actuation of the second transducer;
c) storing a second voltage offset proportional to the second control signal generated by the actuation of the second transducer;
d) enabling control of the device;
e) selectively increasing or decreasing the voltage of the second control signal;
f) proportionally adjusting the voltage of the first and second control signals; and
g) operating the device using the second control signal from the second transducer wherein the second control signal is modified by the second voltage offset.

10. An apparatus comprising:
a) means, comprising first and second transducers that are connected to a powered wheelchair, for moving said powered wheelchair in X and Y direction in response to body member actuating said transducers;
b) means for conditioning a control signal generated by the selective actuating of said transducers;
c) means for enabling or disabling operation of the powered wheelchair;
c) means for storing and applying a voltage offset to the control signal when operation of the powered wheelchair is disabled;
d) means for selecting control of either an external device or the powered wheelchair; and
e) means for selectively increasing or decreasing the voltage of the control signal by a unique voltage selected from a set of voltages to enable operation one of a set of unique powered wheelchairs.

11. The system of claim 10 wherein the voltage of the control signal generated by the first and second transducers may be inverted according to the orientation of the first and second transducers.

12. The system of claim 10 wherein the system further comprises a range-liming module configured to prevent operation of the device by the control signal if the value of the control signal exceeds a specified voltage.

13. The system of claim 10 wherein the system further comprises a signal limiting module configured to limit the voltage of the control signal by automatically adjusting the voltage of the control signal to compensate for rapid changes in the voltage of the control signal.

14. The system of claim 10 wherein the system further comprises a null-width module configured to prevent operation of the device unless the voltage of the control signal exceeds a specified range.

15. The system of claim 10 wherein the system further comprises a rate-of-change adjustment module configured to provide for the adjustment of the rate-of-change of the control signal.

16. The system of claim 10 wherein the system further comprises an X-Y proportioning module configured to proportionally adjusting the voltage of the control signal based on the input from the first and second transducers.

17. A method which comprises:
a) actuating a switch;
b) powering on a device in response to said actuation;
c) if a specified number of input switches are connected to the device, operating the device in a first mode of operation by selectively operating at least one control switch connected to the device wherein the operation of the at least one control switch generates a control signal;
d) if fewer than the specified number of input switches are connected to the device, selecting a second mode of operation in response to a unique operation of the at least one control switch connected to the device;
e) selectively operating a first input switch to increase or decrease the voltage of the control signal; and
f) operating the device in the second mode of operation by selectively operating the at least one control switch connected to the device.

18. An apparatus comprising:
a) means, comprising at least one active or passive switch that are connected to a powered wheelchair, for moving said powered wheelchair in X and Y direction in response to body member actuating said at least one active or passive switch;
b) means, comprising at least one active or passive switch, for alternating control of the powered wheelchair between positive X, negative X, positive Y, and negative Y directions in response to body member actuating said at least one active or passive switch;
c) means for conditioning a control signal generated by the selective actuating of said at least one active or passive switch;
d) means for selecting control of either an external device or the powered wheelchair; and
e) means for selectively increasing or decreasing the voltage of the control signal to enable operation one of a set of unique powered wheelchairs.
